(19) United States
(12) Patent Application Publication
(10) Pub. No.: US 2006/0271431 A1
(43) Pub. Date: Nov. 30, 2006

(54) System and method for operating one or more fuel dispensers

(76) Inventors: Gregory James Wehr, Houston, TX (US); Jaime Alton Park, Houston, TX (US); Monty Stephen Colvin, Houston, TX (US)

Correspondence Address: SHELL OIL COMPANY, P O BOX 2463, HOUSTON, TX, 772522463, US

(21) Appl. No.: 11/391,869

(22) Filed: Mar. 29, 2006

Related U.S. Application Data
(60) Provisional application No. 60/666,783, filed on Mar. 31, 2005.

(51) Int. Cl. G06Q 30/00

(52) U.S. Cl. 705/14

(57) ABSTRACT

A system and method for operating one or more fuel dispensers is described.

### CROSS-REFERENCE TO RELATED APPLICATION

The present application claims the benefit of the filing date of U.S. provisional patent application Ser. No. 60/666,783, filed on Mar. 31, 2005, the disclosure of which is incorporated herein by reference.

### FIELD OF THE INVENTION

The present invention relates to a system and method for operating one or more fuel dispensers.

### BACKGROUND OF THE INVENTION

The present invention relates to a system and method for operating one or more fuel dispensers and according to which one or more marketing routines are executed.

### SUMMARY OF THE INVENTION

According to one aspect of the present invention, a method of operating a fuel dispenser is provided that includes identifying at least one characteristic specific to a customer of the fuel dispenser; and executing one or more marketing routines; wherein at least one of the one or more marketing routines is at least partially dependent upon the at least one characteristic specific to the customer of the fuel dispenser.

According to another aspect of the present invention, a system is provided that includes a host computer; one or more point-of-sale units in communication with the host computer via a network, each of the one or more point-of-sale units adapted to be operably coupled to one or more fuel dispensers; and a computer readable medium operably coupled to the host computer, the computer readable medium comprising a database stored therein, the database comprising a loyalty promotion table; wherein at least a portion of the operation of the one or more fuel dispensers is adapted to be at least partially dependent upon the loyalty promotion table.

According to another aspect of the present invention, a computer readable medium is provided that includes a plurality of instructions stored therein for operating a fuel dispenser, the instructions comprising instructions for identifying at least one characteristic specific to a customer of the fuel dispenser; and instructions for executing one or more marketing routines; wherein at least one of the one or more marketing routines is at least partially dependent upon the at least one characteristic specific to the customer of the fuel dispenser.

According to another aspect of the present invention, a database stored in a computer readable medium and accessible to a device in communication with a fuel dispenser is provided that includes a loyalty promotion table comprising one or more records, each record comprising a discount-type field for identifying a type of reward to apply to a customer of the fuel dispenser; and at least one reward-criteria field for determining whether the reward is available to the customer of the fuel dispenser.

According to another aspect of the present invention, a system for operating a fuel dispenser is provided that includes means for identifying at least one characteristic specific to a customer of the fuel dispenser; and means for executing one or more marketing routines; wherein at least one of the one or more marketing routines is at least partially dependent upon the at least one characteristic specific to the customer of the fuel dispenser.

According to another aspect of the present invention, a method is provided that includes identifying at least one characteristic specific to a customer of a device operably coupled to a point-of-sale unit; and executing one or more marketing routines using the point-of-sale unit; wherein at least one of the one or more marketing routines is at least partially dependent-upon the at least one characteristic specific to the customer.

According to another aspect of the present invention, a computer readable medium is provided that includes a plurality of instructions stored therein, the instructions comprising instructions for identifying at least one characteristic specific to a customer of a device operably coupled to a point-of-sale unit; and instructions for executing one or more marketing routines using the point-of-sale unit; wherein at least one of the one or more marketing routines is at least partially dependent upon the at least one characteristic specific to the customer.

According to another aspect of the present invention, a system is provided that includes means for identifying at least one characteristic specific to a customer of a device operably coupled to a point-of-sale unit; and means for executing one or more marketing routines using the point-of-sale unit; wherein at least one of the one or more marketing routines is at least partially dependent upon the at least one characteristic specific to the customer.

### BRIEF DESCRIPTION OF THE DRAWINGS

FIG. 1 is a schematic view of an exemplary embodiment of a system for operating one or more fuel dispensers.

FIG. 2 is a schematic view of an exemplary embodiment of a point-of-sale (POS) system of the system of FIG. 1.

FIG. 3 is a flow chart illustration of an exemplary embodiment of a method of operating a fuel dispenser.

FIG. 4 is a flow chart illustration of an exemplary embodiment of a pre-fueling marketing routine of the method of FIG. 3.

FIGS. 5A, 5B and 5C are flow chart illustrations of an exemplary embodiment of a step of the pre-fueling marketing routine of FIG. 4.

FIGS. 6A and 6B are flow chart illustrations of an exemplary embodiment of another step of the pre-fueling marketing routine of FIG. 4.

FIGS. 7 and 8 are schematic views of representative screen shots that may be displayed during the execution of a step of the pre-fueling marketing routine of FIG. 4.

FIG. 9 is a flow chart illustration of an exemplary embodiment of a fueling marketing routine of the method of FIG. 3.

FIGS. 10, 11, 12 and 13 are schematic views of representative screen shots that may be displayed during the execution of the fueling marketing routine of FIG. 9.

FIGS. 14A and 14B are flow chart illustrations of an exemplary embodiment of a post-fueling marketing routine of the method of FIG. 3.

FIGS. 15 and 16 are schematic views of representative screen shots that may be displayed during the execution of a step of the post-fueling marketing routine of FIGS. 14A and 14B.

FIGS. 17A and 17B are flow chart illustrations of an exemplary embodiment of a step of the post-fueling marketing routine of FIGS. 14A and 14B.

FIGS. 18 and 19 are schematic views of representative screen shots that may be displayed during the execution of one or more steps of the post-fueling marketing routine of FIGS. 14A and 14B.

FIGS. 20 and 21 are schematic views of representative screen shots that may be displayed during the execution of another step of the post-fueling marketing routine of FIGS. 14A and 14B.

FIGS. 22A, 22B and 22C are flow chart illustrations of an exemplary embodiment of a method of downloading a loyalty promotion table.

FIG. 23 is a schematic view of the contents of the loyalty promotion table of FIGS. 22A, 22B and 22C.

FIG. 24 is a schematic view of the contents of a record of the loyalty promotion table of FIG. 23.

FIG. 25 is a flow chart illustration of an exemplary embodiment of a receipt marketing routine.

FIG. 26 is a flow chart illustration of another exemplary embodiment of a post-fueling marketing routine.

FIGS. 27A and 27B are flow chart illustrations of an exemplary embodiment of a step of the post-fueling marketing routine of FIG. 26.

### DETAILED DESCRIPTION OF THE INVENTION

Conventional fuel dispensing systems suffer from a number of deficiencies. For example, active marketing and/or promotion of products and/or services may not be provided during the operation of conventional fuel dispensing systems, and/or appreciable modification of conventional fuel dispensing systems and/or components and/or systems coupled thereto may be required in order to provide the active marketing and/or promotion of products and/or services during the operation of conventional fuel dispensing systems. The present exemplary embodiments, among other things, address and overcome one or more of the above deficiencies associated with conventional fuel dispensing systems and thereby provide an improved fuel dispensing system.

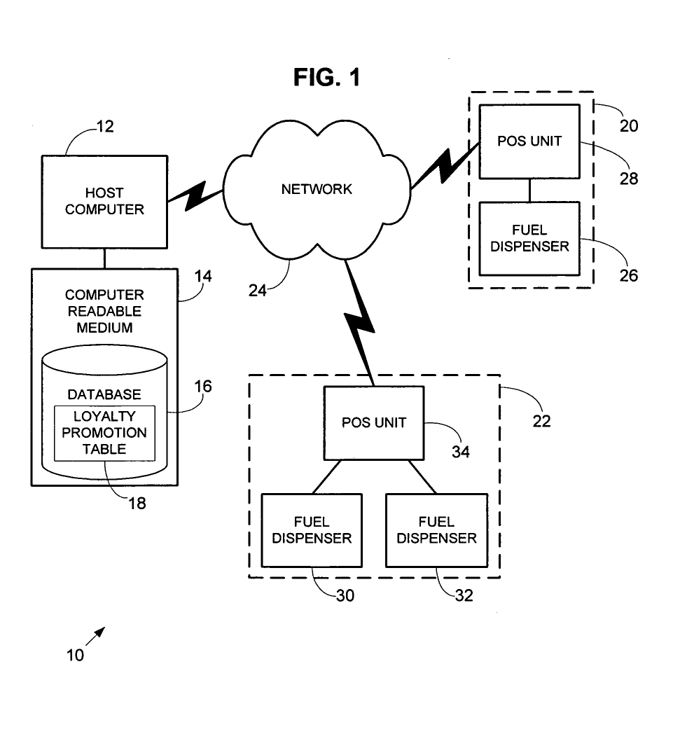

In an exemplary embodiment, as illustrated in FIG. 1, a system for operating one or more fuel dispensers is generally referred to by the reference numeral 10 and includes a host computer 12 and a computer readable medium 14 operably coupled and accessible thereto. Instructions executable by the host computer 12 and a database 16, including a loyalty promotion table 18, are stored in the computer readable medium 14.

Point-of-sale (POS) systems 20 and 22 are in communication with the host computer 12 via a network 24. The network 24 may include, for example, the Internet and/or any type of local area network, wide area network and/or wireless network. The POS system 20 includes a fuel dispenser 26 operably coupled to a POS unit 28, with which the host computer 12 is in communication. In a similar manner, the POS system 22 includes fuel dispensers 30 and 32 that are operably coupled to a POS unit 34, with which the host computer 12 is in communication.

In several exemplary embodiments, the POS unit 28 may be physically integrated with the fuel dispenser 26, or may be physically separated from the fuel dispenser 26. In several exemplary embodiments, the POS unit 34 may be physically integrated with the either of the fuel dispensers 30 or 32, or may be physically separated from the fuel dispensers 30 and 32. In several exemplary embodiments, the quantity of POS systems may range from one to an unlimited number, and that the quantity of POS units and fuel dispensers within each POS system may each range from one to an unlimited number. In several exemplary embodiments, the quantity of host computers may range from one to an unlimited number, and each host computer and each POS system may be positioned at the same or at different locations. In an exemplary embodiment, the host computer 12 may be positioned at a remote location from the POS systems 20 and 22.

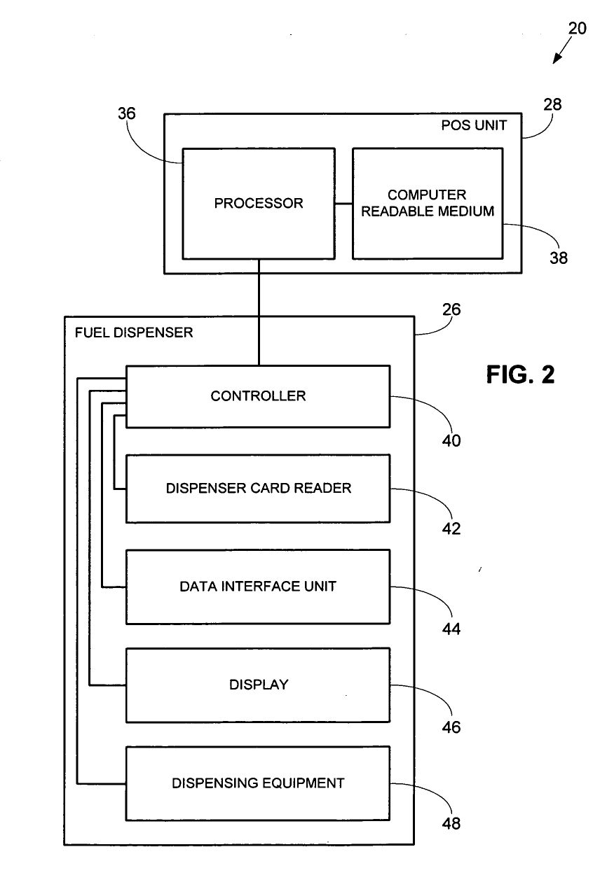

In an exemplary embodiment, as illustrated in FIG. 2, the POS unit 28 includes a processor 36 and a memory or computer readable medium 38 operably coupled and accessible to the processor 36 for storing instructions executable by the processor 36. The fuel dispenser 26 includes a controller 40 in communication with the processor 36. A dispenser card reader 42, a data interface unit 44, a display 46 and dispensing equipment 48 are operably coupled to the controller 40.

In several exemplary embodiments, the fuel dispenser 26 may include one or more additional controllers, dispenser card readers, data interface units, displays and/or fueling equipment that are each substantially similar to the controller 40, the dispenser card reader 42, the data interface unit 44, the display 46 and/or the fueling equipment 48, respectively. Moreover, in several exemplary embodiments, one or more of the foregoing components of the fuel dispenser 26 may be combined with one or more other components of the fuel dispenser 26 such as, for example, the data interface unit 44 may be combined with the display 46 to form a touch-screen data interface configuration. In several exemplary embodiments, the fuel dispenser 26 may include additional fuel-dispenser components such as, for example, a printer for printing receipts.

In an exemplary embodiment, the dispenser card reader 42 may be configured to read and/or accept a wide variety of items such as, for example, a debit card, a credit card, an ATM card, a smart card, bar codes, a contactless smart card, a loyalty card, a coupon, biometric data such as, for example, finger prints or a retinal scan, any other types of payment cards or devices not previously mentioned and/or any combination thereof, and/or the dispenser card reader 42 may be configured to be a cash acceptor, a bill acceptor, a coin acceptor and/or a coupon acceptor. In several exemplary embodiments, the dispenser card reader 42 may read and/or accept one or more of the foregoing items via one or more techniques such as, for example, via the scanning of the item and/or the swiping of the item. The data interface unit 44 may be in the form of or include a keypad, a voice-recognition system and/or any other type of equipment that would enable a customer of the fuel dispenser 26 to enter data for transmission to and receipt by the processor 36 under conditions to be described. The display 46 may be in the form of or include one or more digital displays, liquid crystal displays and/or any other types of displays. The dispensing equipment 48 may include, for example, nozzles, hoses, valves, handles and/or any other components of fuel-dispensing equipment and systems.

The POS system 22 is substantially similar to the POS system 20 and therefore will not be described in detail. In several exemplary embodiments, the platforms of the POS units 28 and 34 may be identical or different, and therefore may vary with respect to equipment, peripherals, hardware and/or software architecture and/or specifications. In several exemplary embodiments, the fuel dispensers 26, 30 and 32 may each be in the form of one of a wide variety of types of fuel dispensers.

In several exemplary embodiments, the computer readable medium 14, and the contents stored therein, may be distributed throughout the system 10. For example, the computer readable medium 14 and the contents stored therein may be distributed across a plurality of file servers, and/or across one or more POS units such as, for example, the POS unit 28 and/or the POS unit 34. Similarly, the database 16 and/or the loyalty promotion table 18 may be distributed throughout the system 10. For example, the database 16 and/or the loyalty promotion table 18 may be stored in a plurality of file servers, and/or in one or more POS units, such as, for example, the POS unit 28 and/or the POS unit 34. Moreover, in several exemplary embodiments, the host computer 12 may be in the form of one or more computers and/or may be in the form of one or more POS units such as, for example, the POS unit 28 and/or the POS unit 34.

In an exemplary embodiment, and in operation, the host computer 12, via the network 24, downloads to the POS unit 28, at one or more predetermined times and for storage in the computer readable medium 38, instructions and/or data stored in the computer readable medium 14, including the database 16, and downloads to the POS 28 unit the loyalty promotion table 18 in a manner described in detail below. The processor 36 of the POS unit 28 controls the operation of the fuel dispenser 26 by communicating with the controller 40 which, in turn, controls the operation of the dispenser card reader 42, the data interface unit 44, the display 46, the dispensing equipment 48 and the other components of the fuel dispenser 26.

To control the fuel dispenser 26, the processor 36 executes instructions stored in the computer readable medium 38, including at least a portion of the instructions downloaded by the host computer 12 via the network 24. In view of the foregoing, and in an exemplary embodiment, the POS system 20 may be characterized as a thick client.

In an exemplary embodiment, the execution of the instructions downloaded from the host computer 12 may be dependent upon the data and the loyalty promotion table 18 downloaded from the database 16. Data received by one or more components of the fuel dispenser 26, in response to the operation of the fuel dispenser 26 by a customer, is stored in the computer readable medium 38 and/or is uploaded to the host computer 12 via the network 24 for storage in the database 16. In an exemplary embodiment, the execution of the instructions downloaded from the host computer 12 may be at least partially dependent upon the data received by the one or more components of the fuel dispenser 26, in response to the operation of the fuel dispenser 26 by a customer.

In another exemplary embodiment, the POS system 20 may be a thin client and the host computer 12 may control at least a portion of the operation of the fuel dispenser 26 by executing instructions stored in the computer readable medium 14 and communicating with the controller 40 via the network 24 and the processor 36 of the POS unit 28, with the controller 40 in turn controlling the operation of the dispenser card reader 42, the data interface unit 44, the display 46, the dispensing equipment 48 and the other components of the fuel dispenser 26. As discussed above, data received by one or more components of the fuel dispenser 26, in response to the operation of the fuel dispenser 26 by a customer, may be stored in the computer readable medium 38 and/or may be uploaded to the host computer 12 via the network 24 for storage in the database 16, and the execution of the instructions stored in the computer readable medium 14 by the host computer 12 may be at least partially dependent upon the data received.

During the following operational discussion of the system 10, it is assumed that the POS system 20 functions as a thick client. However, in several exemplary embodiments, the POS system 20 may instead function as a thin client during the operation of the system 10, and therefore the functions and/or uses of the processor 36 and/or the computer readable medium 38 may instead be functions and/or uses of the host computer 12 and/or the computer readable medium 14, respectively. Moreover, in several exemplary embodiments, the POS system 20 may function as both a thin client and a thick client, with the degree to which the POS system 20 functions as a thin client and/or a thick client being dependent upon a variety of factors including, but not limited to, the instructions stored in the computer readable medium 38 for execution by the processor 36.

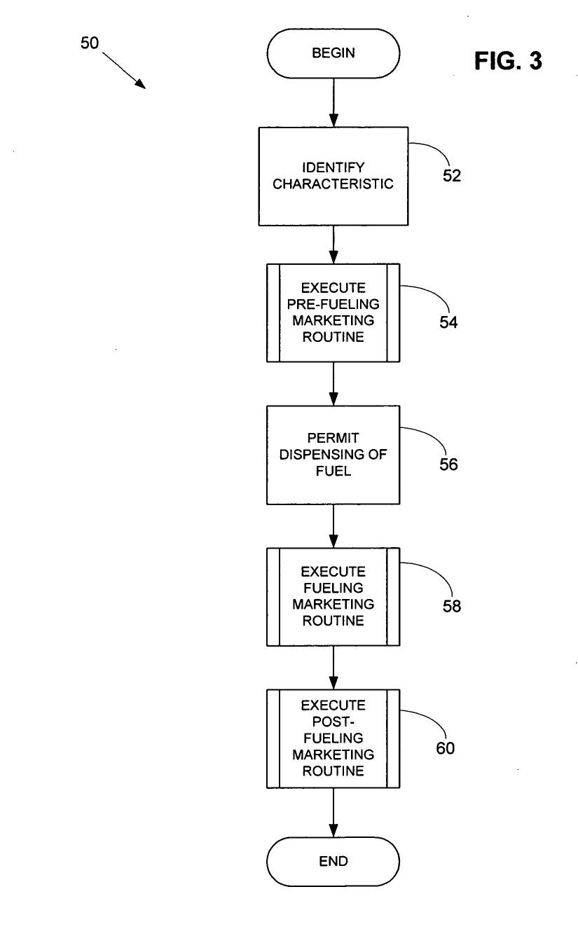

Referring to FIG. 3, during operation of the system 10, the host computer 12 and/or the processor 36 implements a method 50 rewarding, communicating one or more marketing messages to and/or soliciting data from a customer of the fuel dispenser 26. In step 52, at least one characteristic specific to the customer of the fuel dispenser 26 is identified. In an exemplary embodiment, the characteristic may be the payment type used by the customer such as, for example, a proprietary credit card payment such as a Shell™ credit card payment, a branded credit card payment such as a Shell™ Mastercard™ credit card payment, a third party credit card payment, a debit card payment, a cash payment or a coupon payment. In an exemplary embodiment, the payment type may be identified in response to the customer engaging one of the aforementioned payment cards with the dispenser card reader 42.

In several exemplary embodiments, the identifying characteristic specific to the customer of the fuel dispenser 26 may be the geographic area in which the fuel dispenser 26, and thus the customer, are located, the product type desired by the customer such as, for example, the particular grade of gasoline desired by the customer, a loyalty identifier used by the customer or data specific to the customer such as, for example, the residence address of the customer, past-purchases of the customer, profile-based lifestyle demographic information, past-purchase patterns and/or trends of the customer, and/or preferences of the customer, which may be identified through, for example, the use of syndicated data. In several exemplary embodiments, the characteristic identified in the step 52 may be identified in response to the identification of one or more other characteristics of the customer. For example, the data specific to the customer may be identified by, for example, determining one or more identifying characteristics of the customer and the customer information associated with the payment type used by the customer such as, for example, a proprietary credit card such as, for example, the Shell™ credit card. In an exemplary embodiment, the data specific to the customer, including the one or more identifying characteristics of the customer and the customer information, may be stored in the database 16.

In another exemplary embodiment, the customer may be prompted via the display 46 to enter data via the data interface unit 44, in which case the data would serve as the identifying characteristic. Examples of data that may be entered via the data interface unit 44 include, but are not limited to, a telephone number, a zip code, the last four digits of the customer's social security number, and/or personal information specific to the customer such as, for example, the customer's name, mailing address, driver's license number and/or e-mail address. In another exemplary embodiment, the data specific to the customer may be biometric data such as, for example, fingerprint data and/or retinal scan data. Examples of loyalty identifiers used by the customer may include, but are not limited to, data received via the reading of a loyalty card by the dispenser card reader 42, a loyalty coupon read by the dispenser card reader 42 and/or a loyalty code entered by the customer via the data interface unit 44. In an exemplary embodiment, the loyalty identifier may include data received via the reading of a loyalty card by the dispenser card reader 42 in response to, for example, the customer swiping the loyalty card through the dispenser card reader 42 before or after swiping a payment card through the dispenser card reader 42, or instead of swiping a payment card through the dispenser card reader 42, resulting in either a dual-swipe configuration or a single-swipe configuration, respectively. In another exemplary embodiment, the loyalty identifier may include a loyalty code entered by the customer via the data interface unit 44, with the loyalty code being determined by the customer by, for example, browsing a web site. In an exemplary embodiment, the identifying characteristic may be transmitted to the computer readable medium 38, the computer readable medium 14, the database 16, the loyalty promotion table 18 and/or any combination thereof, for storage therein.

After the step 52, a pre-fueling marketing routine is executed in step 54, after which the customer is permitted to dispense fuel from the dispensing equipment 48 in step 56. In an exemplary embodiment, the pre-fueling marketing routine executed in the step 54 may be at least partially dependent upon the characteristic identified in the step 52. In an exemplary embodiment, the step 56 may include authorizing the use of one of the aforementioned payment cards by the customer, and may further include instructing the customer to begin fueling by displaying a “Begin Fueling” message, or an equivalent message, on the display 46. In an exemplary embodiment, the execution of the step 56 may be dependent upon the customer lifting a handle of the dispensing equipment 48, pushing a start button coupled to the fuel dispenser 26, selecting a grade of gasoline and/or initiating fueling in one or more other manners.

During the dispensing of fuel by the customer, and/or during the time period in which the customer is permitted to dispense fuel, a fueling marketing routine is executed in step 58. In an exemplary embodiment, the fueling marketing routine executed in the step 58 may be at least partially dependent upon the characteristic identified in the step 52. After the step 58, a post-fueling marketing routine is executed in step 60. In an exemplary embodiment, the post-fueling marketing routine executed in the step 60 may be at least partially dependent upon the characteristic identified in the step 52.

In several exemplary embodiments, one or more other steps may be executed before, during and/or after each of the steps 52, 54, 56, 58 and 60 such as, for example, executing a carwash routine in which, for example, the customer is asked whether he or she desires a car wash and an appropriate charge is applied and a car wash code is provided to the customer. Further, in an exemplary embodiment, the purchase of the car wash by the customer may serve as a product type desired by the customer, and therefore the characteristic specific to the use of the fuel dispenser 26 by the customer, which is identified in the step 52. Other steps may include executing purchase settlement and receipt routines in which, for example, the total cost to the customer is calculated and a receipt is printed. In several exemplary embodiments, in addition to purchasing a car wash as described above, additional steps may be executed before, during and/or after each of the steps 52, 54, 56, 58 and 60 such as, for example, executing purchase routines in which the customer is given the opportunity to purchase a wide variety of services and/or products such as, for example, motor oil, coffee and automotive-maintenance services. In several exemplary embodiments, the customer's purchase of such products and/or services may serve as the product type desired by the customer, and therefore the characteristic specific to the customer. In several exemplary embodiments, one or more of the steps 52, 54, 56, 58 and 60 may be omitted from the method 50.

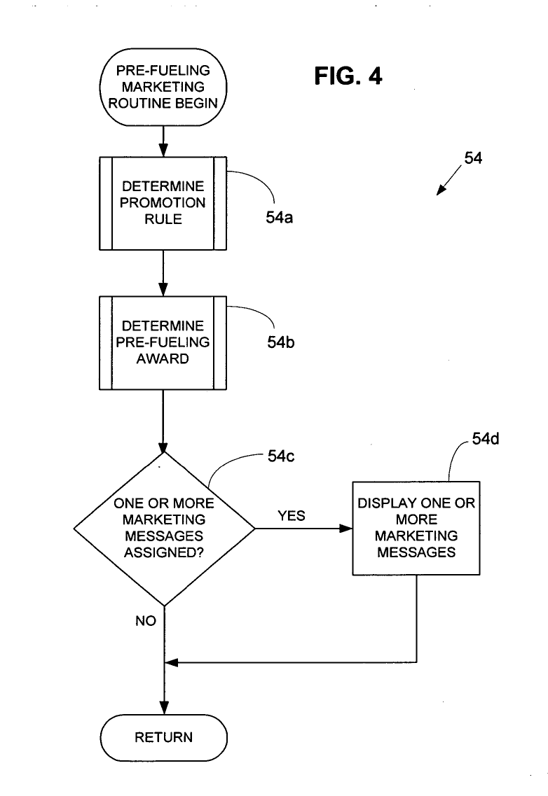

To execute the pre-fueling marketing routine in the step 54 of the method 50, as illustrated in FIG. 4, a promotion rule is determined in step 54a, after which a pre-fueling award is determined in step 54b. The determination as to whether one or more marketing messages are assigned is executed in step 54c and, if the one or more marketing messages are so assigned, the one or more marketing messages are displayed via the display 46 in step 54d. In an exemplary embodiment, the determination of the promotion rule in the step 54a may be at least partially dependent upon the identifying characteristic identified in the step 52. In an exemplary embodiment, the form, or content, of the one or more marketing messages displayed in the step 54d may be at least partially dependent upon the identifying characteristic identified in the step 52.

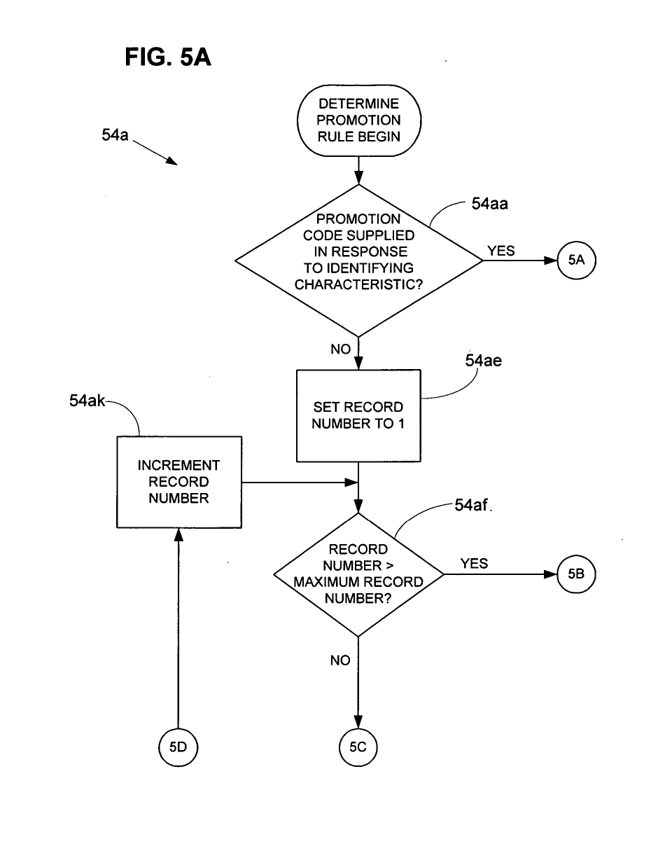

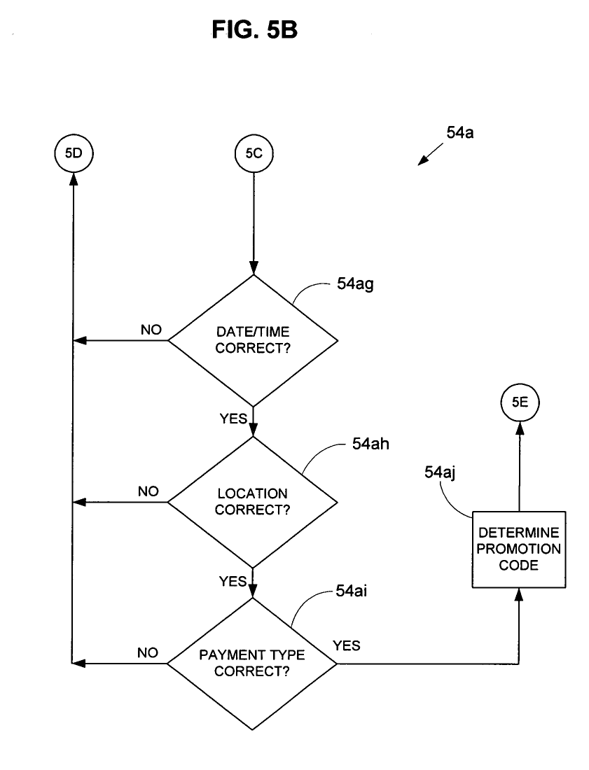

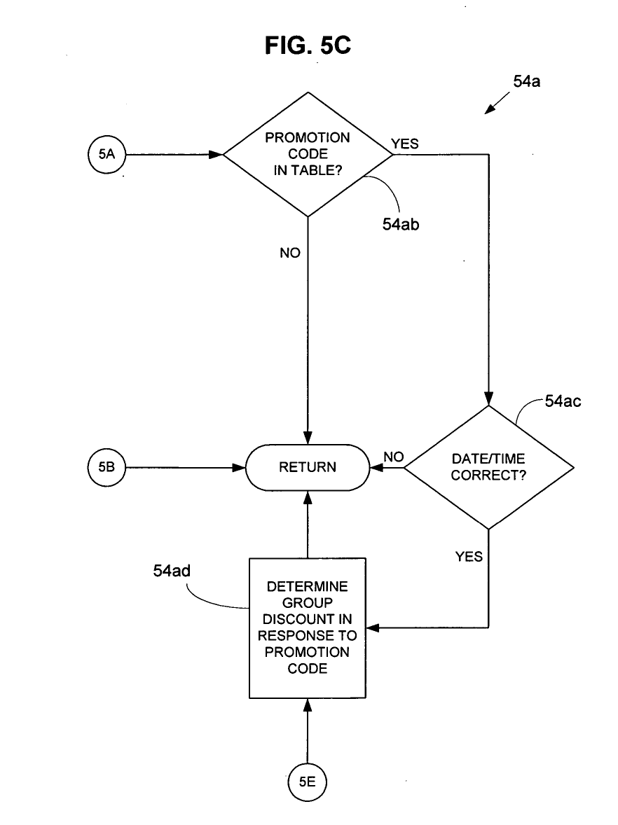

To determine the promotion rule in the step 54a, as illustrated in FIGS. 5A-5C, it is determined whether a promotion code is supplied in response to the identifying characteristic in step 54aa. In an exemplary embodiment, the identifying characteristic may be transmitted from the POS unit 28 to the host computer 12 via the network 24 and, in response, a promotion code stored in the database 16 in the computer readable medium 14 may be identified and transmitted to the processor 36.

If a promotion code is indeed identified and transmitted, the presence of the promotion code in the loyalty promotion table 18 that is stored in the computer readable medium 38 is determined in step 54ab and, if the promotion code is present, it is determined in step 54ac whether the current date and time of use of the fuel dispenser 26 by the customer falls between the start date/time and the end date/time associated with the promotion code. If the current date and time does fall between the start and end dates and times, a group discount associated with the promotion code is determined in step 54ad, with the group discount being a discount applicable to one or more POS systems, including the POS system 20. In an exemplary embodiment, the group discount may be a global discount applicable to all of the POS systems in the system 10, or the group discount may be a regional discount applicable to, for example, one or more POS systems in a geographic region. For the step 54ac, in several exemplary embodiments, the start date/time and the end date/time associated with the promotion code may define a wide variety of date/time range configurations in which the current date and time may fall between and be correct such as, for example, a chronological length of time such as a week or three days, a reoccurring date associated with a particular day or days of the week such as every Saturday and Sunday, a reoccurring time period associated with every day of the week such as 3:00 p.m. to 9:00 p.m. every day, a reoccurring date and time slot associated with a particular day or days of the week such as every Monday and Tuesday morning from 4:00 a.m. to 12:00 p.m., and/or any combination thereof.

If a promotion code is not identified in the step 54aa, a record number is initialized and set to one in step 54ae and, in step 54af, it is determined whether the record number is greater than the maximum number of records in the loyalty promotion table 18, which comprises a series of records with each record associated with a different promotion code. In an exemplary embodiment, the loyalty promotion table 18 may include one or more records.

If the record number is not greater than the maximum number of records, as determined in the step 54af, it is determined whether the current date and time falls between the start and end dates and times associated with the promotion code in record number one of the loyalty promotion table 18 in step 54ag, whether the promotion code in record number one of the loyalty promotion table 18 applies to a location associated with the use of fuel dispenser 26 in step 54ah, and whether the promotion code in record number one of the loyalty promotion table 18 applies to the payment type used by the customer of the fuel dispenser 26 in step 54ai. In an exemplary embodiment, the location associated with the use of the fuel dispenser 26 in the step 54ah may include the location where the customer is paying for the fuel and/or other products and/or services, either indoors in a store or outdoors at the fuel dispenser 26, and/or may include the geographic area in which the fuel dispenser 26 is located.

If the current date and time falls between the start and end dates and times associated with the promotion code in record number one of the loyalty promotion table 18 in the step 54ag, and the promotion code in record number one applies to the location associated with the use of the fuel dispenser 26 and the payment type used by the customer in the steps 54ah and 54ai, respectively, then the promotion code in the record number one is determined in step 54aj. A group discount associated with the promotion code is then determined in the step 54ad, with the group discount being a discount applicable to one or more POS systems, including the POS system 20. In an exemplary embodiment, the group discount may be a global discount applicable to all of the POS systems in the system 10, or the group discount may be a regional discount applicable to, for example, one or more POS systems in a geographic region. For the step 54ag, in several exemplary embodiments, the start date/time and the end date/time associated with the promotion code may define a wide variety of date/time range configurations in which the current date and time may fall between and be correct such as, for example, a chronological length of time such as a week or three days, a reoccurring date associated with a particular day or days of the week such as every Saturday and Sunday, a reoccurring time period associated with every day of the week such as 3:00 p.m. to 9:00 p.m. every day, a reoccurring date and time slot associated with a particular day or days of the week such as every Monday and Tuesday morning from 4:00 a.m. to 12:00 p.m., and/or any combination thereof.

If the current date and time does not fall between the start and end dates and times associated with the promotion code in record number one of the loyalty promotion table 18 as determined in the step 54ag, or the promotion code in record number one does not apply to the location associated with the use of the fuel dispenser 26 as determined in the step 54ah, or the promotion code in record number one does not apply to the payment type used by the customer as determined in the step 54ai, then the record number is incremented by an increment such as, for example, one, in step 54ak. The steps 54af, 54ag, 54ah, 54ai and 54ak may then be repeated as discussed above, with the record number being equal to one plus the increment. For example, if the increment is one, then the record number would be equal to two during the execution of the steps 54af, 54ag, 54ah, 54ai and 54ak.

The loop created by the steps 54af, 54ag, 54ah, 54ai and 54ak is repeated until the current record number is greater than the maximum number of records in the loyalty promotion table 18, as determined in the step 54af, or until the step 54aj is executed under the conditions described above.

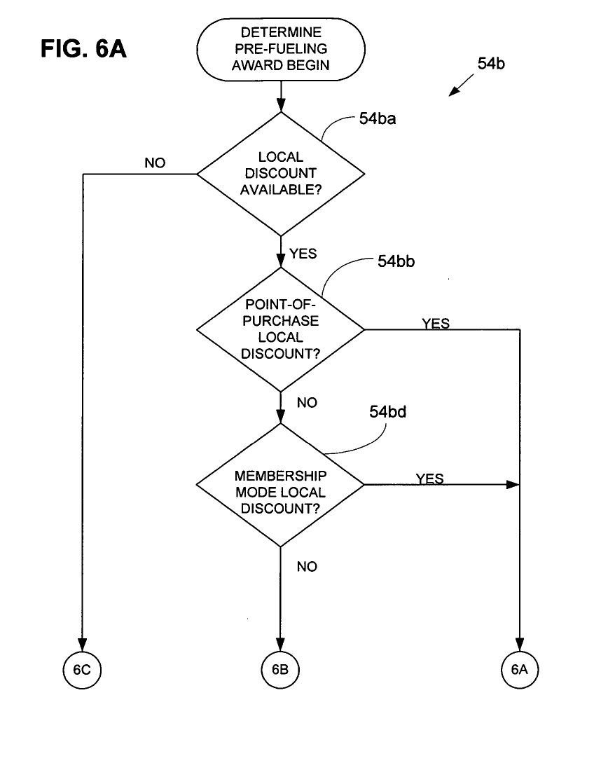

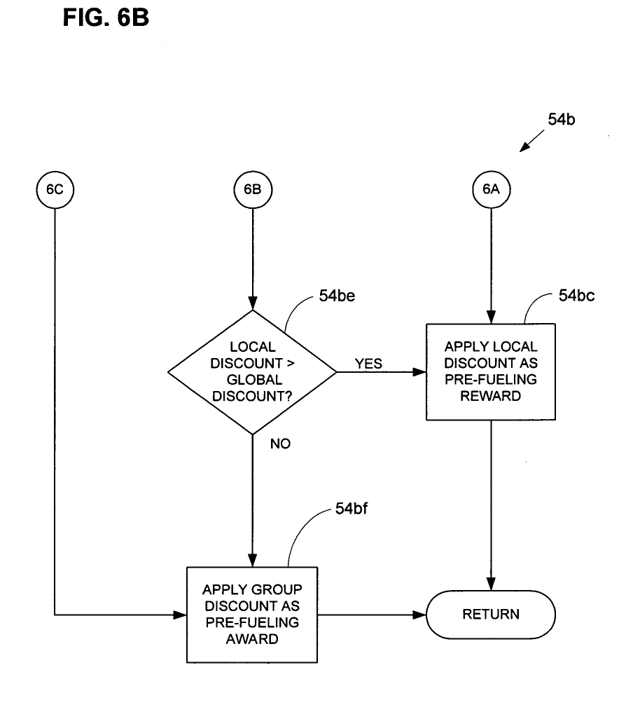

To determine the pre-fueling award in the step 54b, as illustrated in FIGS. 6A-6B, it is determined whether a local discount is available in step 54ba, with the local discount being a discount specifically applicable to the POS system 20.

If a local discount is available as determined in the step 54ba, it is determined in step 54bb whether the local discount is associated with a customer-entered point-of-purchase code and, if so, the local discount is applied as the pre-fueling award in step 54bc, and the pre-fueling award is provided to the customer of the fuel dispenser 26. If the local discount is not associated with a point-of-purchase code in the step 54bb, it is determined in step 54bd whether the local discount is associated with a membership-mode discount and, if so, the local discount is applied as the pre-fueling award in the step 54bc. If the local discount is not associated with a membership-mode discount in the step 54bd, then the group discount determined in the step 54ad is compared with the local discount determined to be available in the step 54ba and it is determined, in step 54be, whether the local discount is a larger immediate discount to the customer of the fuel dispenser 26 than the group discount. If the local discount is a larger immediate discount than the group discount, then the local discount is applied as the pre-fueling award in the step 54bc, and the pre-fueling award is provided to the customer of the fuel dispenser 26. If the local discount is not a larger immediate discount than the group discount, then the group discount is applied as the pre-fueling award in step 54bf, and the pre-fueling award is provided to the customer of the fuel dispenser 26.

If a local discount is not available as determined in the step 54ba, then the group discount is applied as the pre-fueling award in the step 54bf, and the pre-fueling award is provided to the customer of the fuel dispenser 26.

In an exemplary embodiment, the pre-fueling award applied in the step 54bf may be in the form of a coupon which may be in the form of, for example, text or a scannable bar code printed on the receipt for payment for the fuel dispensed from the fuel dispenser 26. In another exemplary embodiment, the pre-fueling award applied in the step 54bf may be in the form of a percentage discount off of the price of the fuel to be purchased such as, for example, a 5% discount off of the advertised price per gallon of fuel. In another exemplary embodiment, the pre-fueling award applied in the step 54bf may be in the form of a cent-per-quantity discount off of the price of the fuel to be purchased such as, for example, a $0.05 discount per gallon of fuel purchased. In another exemplary embodiment, the pre-fueling award applied in the step 54bf may be in the form of a dollar-value discount off of the price of the fuel to be purchased such as, for example, $2.00 off of the price of the fuel to be purchased. In another exemplary embodiment, the pre-fueling award applied in the step 54bf may be in the form of a discount that is limited to a maximum dollar value such as, for example, $5.00.

In several exemplary embodiments, the group discount, the local discount and/or the pre-fueling award may be in the form of, for example, any type of discount off of the price of any type of service and/or product, a credit to be applied to the price of any type of service and/or product, and/or a free service and/or product, including, but not limited to, services and/or products purchased at the fuel dispenser 26 via, for example, the data interface unit 44 and/or the display 46, and/or services and/or products purchased at a location other than at the fuel dispenser 26. Further, in several exemplary embodiments, the pre-fueling award provided to the customer of the fuel dispenser 26, along with the at least one characteristic identified in the step 52 may be captured and stored in the computer readable medium 38, and/or may be transmitted to and captured and stored in the database 16 via the network 24 and the host computer 12.

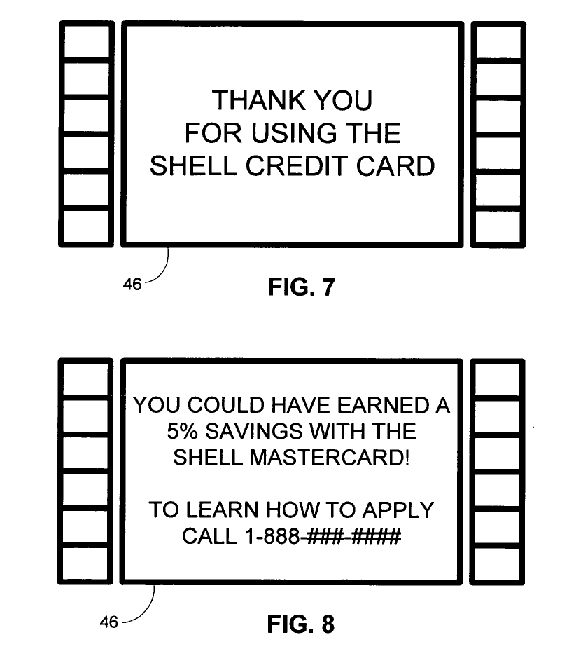

In an exemplary embodiment, as illustrated in FIG. 7, the one or more marketing messages displayed in the step 54d of the pre-fueling marketing routine 54 may be in response to the payment type used by the customer of the fuel dispenser 26. For example, the payment type may be in the form of a proprietary credit card payment and at least one marketing message may be in the form of a thank you message to the customer for using the proprietary credit card.

In another exemplary embodiment, as illustrated in FIG. 8, the one or more marketing messages displayed in the step 54d may be in the form of a marketing message encouraging the customer to apply for a branded credit card, and informing the customer of a missed pre-fueling award such as, for example, a missed rebate to be applied to a future gasoline purchase, because the customer is not presently a holder of the branded credit card.

In another exemplary embodiment, the one or more marketing messages displayed in the step 54d of the pre-fueling marketing routine 54 may be in response to the pre-fueling award provided to the customer of the fuel dispenser 26, and may be in the form of a congratulatory message informing the customer of the provision of the pre-fueling reward to the customer. If the pre-fueling award is dependent upon the payment, type being a branded credit card payment, one marketing message could be in the form of “Congratulations you have earned a 5% discount with your Shell Mastercard today.”

In another exemplary embodiment, the one or more marketing messages displayed in the step 54d of the pre-fueling marketing routine 54 may be in the form of an informational message informing the customer of the fuel dispenser 26 of an available discount off of the price of a potential purchase in the vicinity of the fuel dispenser 26 such as, for example, informing the customer of a discount on a cup of coffee in the store in which the POS unit 28 is housed.

In several exemplary embodiments, a wide variety of other marketing messages may be displayed in the step 54d, and may be directed to informing the customer of any pre-fueling awards provided, any pre-fueling awards missed, encouraging the customer to purchase and/or acquire services or products, and/or soliciting data from the customer. The content of these marketing messages may be at least partially dependent upon the characteristic identified in the step 52.

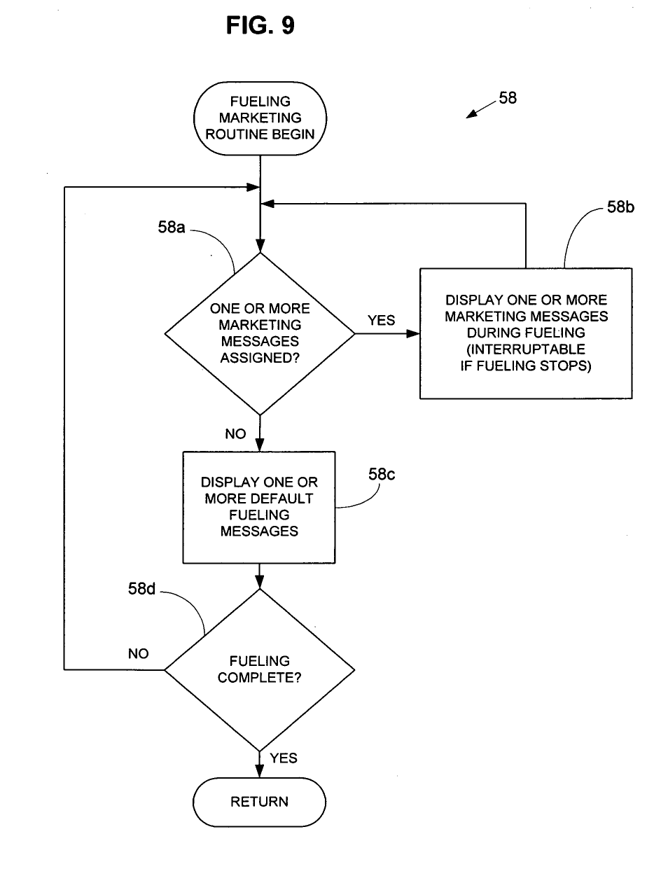

To execute the fueling marketing routine in the step 58 of the method 50, as illustrated in FIG. 9, it is determined whether one or more marketing messages are assigned in step 58a. The criteria for the determination in the step 58a may be the characteristic identified in the step 52, the promotion code determined in the step 54aj and/or the pre-fueling award provided to the customer in the step 54bc or 54bf.

If it is determined that one or more marketing messages are assigned in the step 58a, the one or more marketing messages are communicated to the customer by displaying the one or more marketing messages on the display 46 in step 58b. In an exemplary embodiment, the form, or content, of the one or more marketing messages communicated in the step 58b may be at least partially dependent upon the characteristic identified in the step 52.

In several exemplary embodiments, instead of, or in addition to displaying the one or more marketing messages on the display 46, the one or more marketing messages may be communicated to the customer via a wide variety of multimedia and/or multimedia techniques such as, for example, via the printing of the one or more marketing messages on a coupon and/or other type of paper, via the playing of audio recordings of the one or more marketing messages over an audio speaker coupled to the fuel dispenser 26, and/or via any other type of multimedia and/or tangible medium including, but not limited to, any type of audio media, any type of print media, any type of video or visual media including, but not limited to, animation, one or more still images and/or live-action video, and/or any combination thereof. The step 58a is again repeated and, if it is determined in the step 58a that additional one or more marketing messages are assigned, additional one or more marketing messages are displayed on the display 46. The steps 58a and 58b are repeated until it is determined in the step 58a that no more marketing messages are assigned, at which point one or more default fueling messages are displayed on the display 46 in step 58c. In an exemplary embodiment, the default fueling message may be in the form of “Thank you for choosing Shell.” In an exemplary embodiment, the execution of the steps 58a and 58b may be interrupted and stopped if the dispensing of the fuel by the customer is stopped or completed. It is determined in step 58d whether fueling is completed and, if not, the step 58a is repeated, followed by the steps 58b and/or 58c.

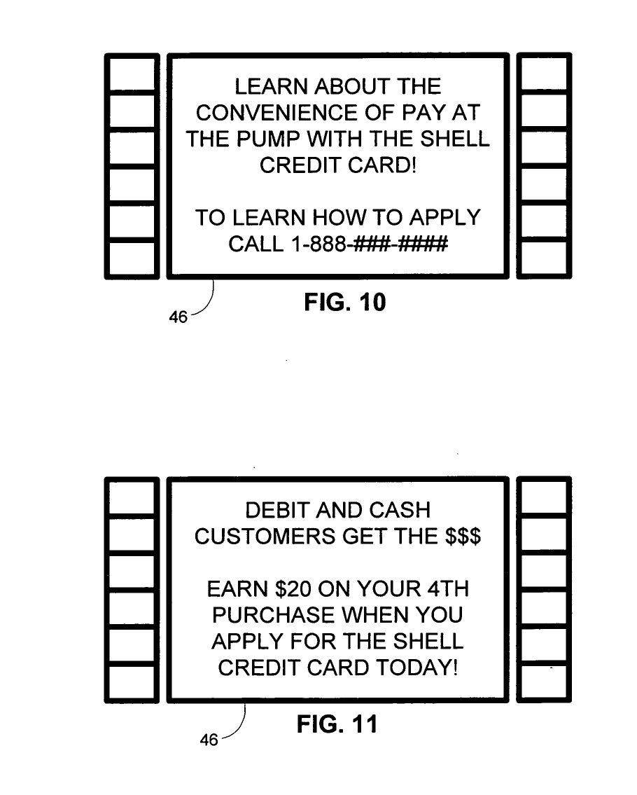

In an exemplary embodiment, the marketing message may be assigned in the step 58a, and may be displayed in the step 58b, in response to the payment type used by the customer. In an exemplary embodiment, as illustrated in FIG. 10, if the payment type is not in the form of a proprietary credit card payment, the marketing message displayed in the step 58b may be in the form of an informational marketing message encouraging the customer to apply for the proprietary credit card.

In another exemplary embodiment, as illustrated in FIG. 11, if the payment type is not in the form of a proprietary credit card payment, the marketing message displayed in the step 58b may be in the form of an informational marketing message informing the customer of at least one incentive in connection with applying for the predetermined credit card.

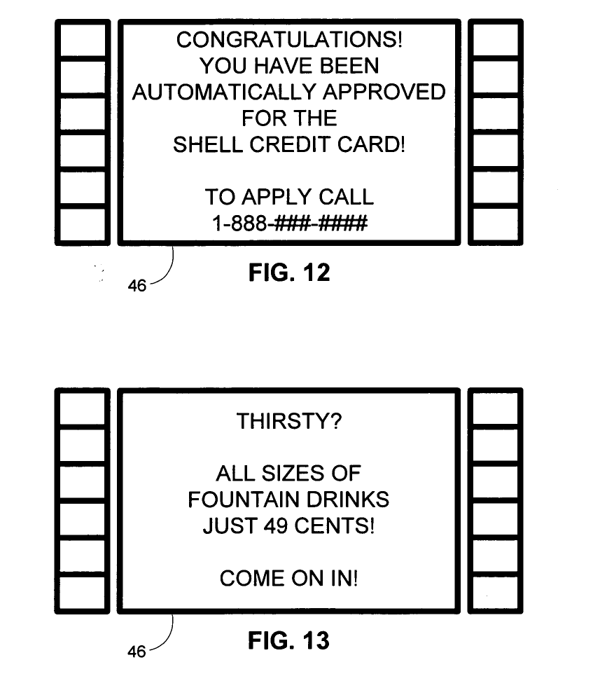

In another exemplary embodiment, as illustrated in FIG. 12, if the payment type is not in the form of a proprietary credit card payment, the method 50 may include approving the customer for the proprietary credit card, and the marketing message displayed in the step 58b may be in the form of an informational marketing message informing the customer that the customer has automatically been approved for the proprietary credit card. In an exemplary embodiment, instead of a proprietary card, the customer could be approved for a branded credit card or a third party credit card or another type of payment card. Further, in an exemplary embodiment, the marketing message displayed in the step 58b may be in the form of a question asking whether the customer would like to apply for a predetermined credit card.

In another exemplary embodiment, as illustrated in FIG. 13, the marketing message displayed in the step 58b may be in the form of an informational message informing the customer of an available discount off of the price of a potential purchase in the vicinity of the fuel dispenser 26 such as, for example, off of the price of fountain drinks in the store in which the POS unit 28 is housed.

In an exemplary embodiment, the marketing message may be assigned in the step 58a, and may be displayed in the step 58b, in response to the payment type used by the customer. In an exemplary embodiment, if the payment type is in the form of a proprietary credit card payment, the marketing message displayed in the step 58b may be in the form of a thank you message to the customer for using the proprietary credit card, similar to that depicted in FIG. 7.

In an exemplary embodiment, the marketing message may be assigned in the step 58a, and may be displayed in the step 58b, in response to the payment type used by the customer. In an exemplary embodiment, if the payment type is not in the form of a proprietary credit card payment or a branded credit card payment, the marketing message displayed in the step 58b may be in the form of an informational marketing message informing the customer of the discount that would have been available to the customer had the payment type been in the form of a proprietary credit card payment or a branded credit card payment. For example, if the payment type is not in the form of a branded credit card payment, the marketing message displayed in the step 58b may be in the form of a message similar to that depicted in FIG. 8.

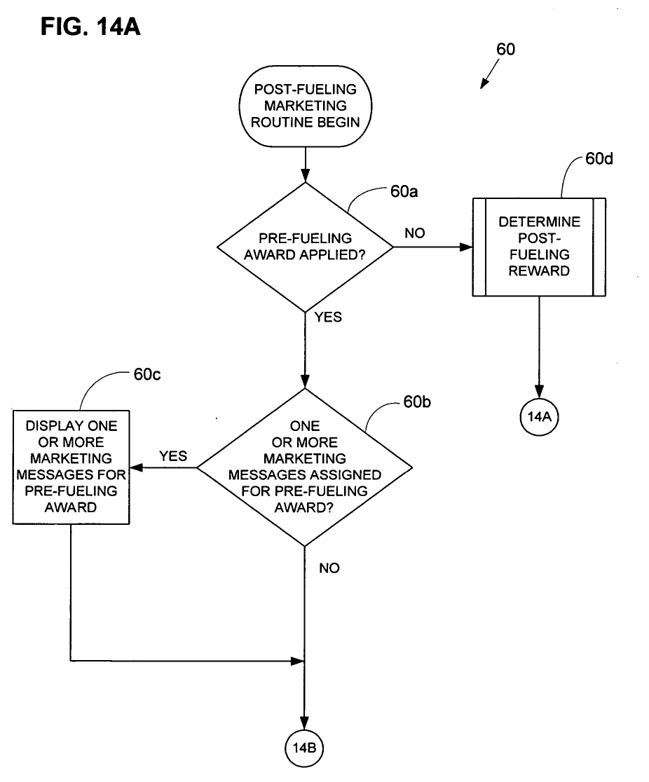

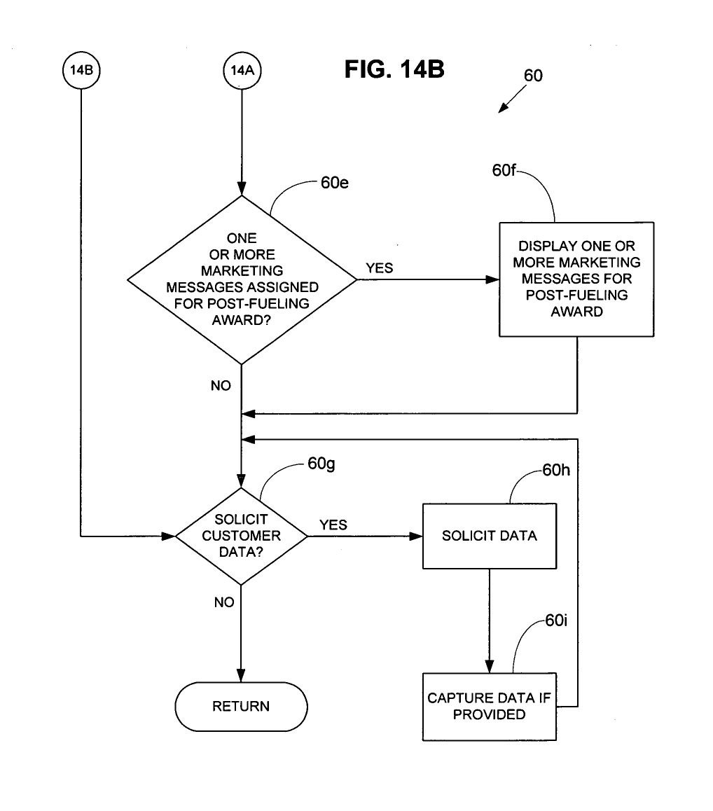

To execute the post-fueling marketing routine in the step 60 of the method 50, as illustrated in FIGS. 14A through 14B, it is determined in step 60a whether a pre-fueling award was applied and provided to the customer in the pre-fueling marketing routine in the step 54 and, if so, it is determined in step 60b whether one or more marketing messages are assigned for the pre-fueling award. If one or more marketing messages are assigned in the step 60b, the one or more marketing messages for the pre-fueling award are displayed on the display 46.

If it is determined in the step 60a that a pre-fueling award was not applied and provided to the customer in the pre-fueling marketing routine in the step 54, then a post-fueling award is determined in step 60d. It is next determined in step 60e whether one or more marketing messages are assigned for the post-fueling award and, if so, one or more marketing messages are displayed on the display 46 in step 60f. In an exemplary embodiment, the determination of a post-fueling award in the step 60d does not have to be dependent upon whether a pre-fueling award was applied as determined in the step 60a. That is, in several exemplary embodiments, instead of either a pre-fueling award or a post-fueling award being applied, both a pre-fueling award and a post-fueling award may be applied to the customer of the fuel dispenser 26.

After the steps 60b and/or 60c, or the step 60e, it is determined in step 60g whether data is to be solicited from the customer and, if so, data is solicited from the customer in step 60h and the data, if provided by the customer, is captured in step 60i. The step 60g is again repeated and, if it is determined in the step 60g that additional data is to be solicited from the customer, additional data is solicited in the step 60h and the additional data, if provided by the customer, is captured in the step 60i. The steps 60g, 60h and 60i are repeated until it is determined that no more data is to be solicited from the customer. In an exemplary embodiment, the type of the data solicited in the step 60h may be at least partially dependent upon the characteristic identified in the step 52.

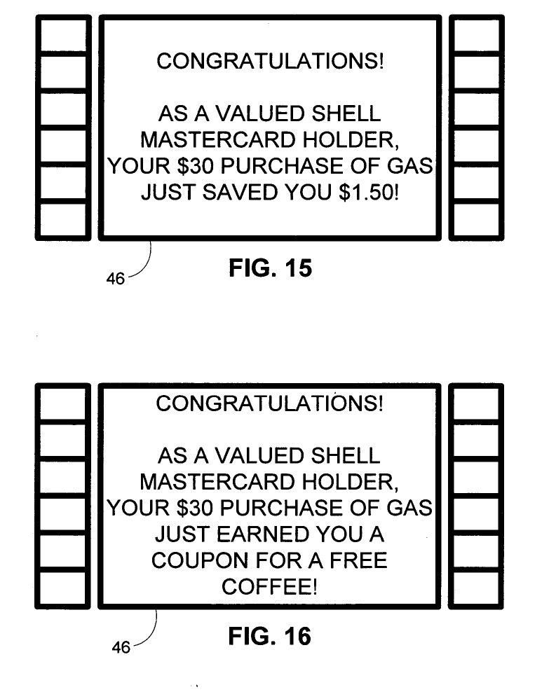

In an exemplary embodiment, as illustrated in FIG. 15, the marketing message for the pre-fueling award displayed in the step 60c may be in the form of a congratulatory message that indicates that the pre-fueling award has been provided and that informs the customer of the total discount received, with the discount being in the form of a cent-per-quantity discount off of the price of each gallon of fuel purchased and the total discount being displayed on the display 46 equaling the cent-per-quantity discount multiplied by the number of gallons of fuel purchased by the customer.

In an exemplary embodiment, the marketing message for the pre-fueling award displayed in the step 60c may be in the form of a congratulatory message that indicates that the pre-fueling award has been provided and that informs the customer of the total discount received, with the discount being in the form of a coupon for a free product, and the free product being dependent upon a minimum amount of fuel purchased by the customer. For example, as illustrated in FIG. 16, the discount may be in the form of a coupon for a free cup of coffee in response to the purchase of $30.00 worth of fuel by the customer.

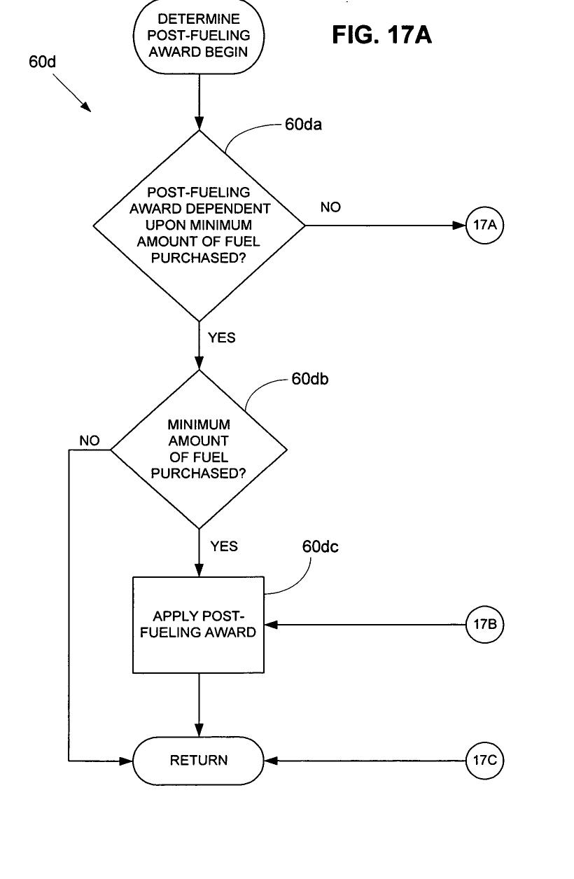

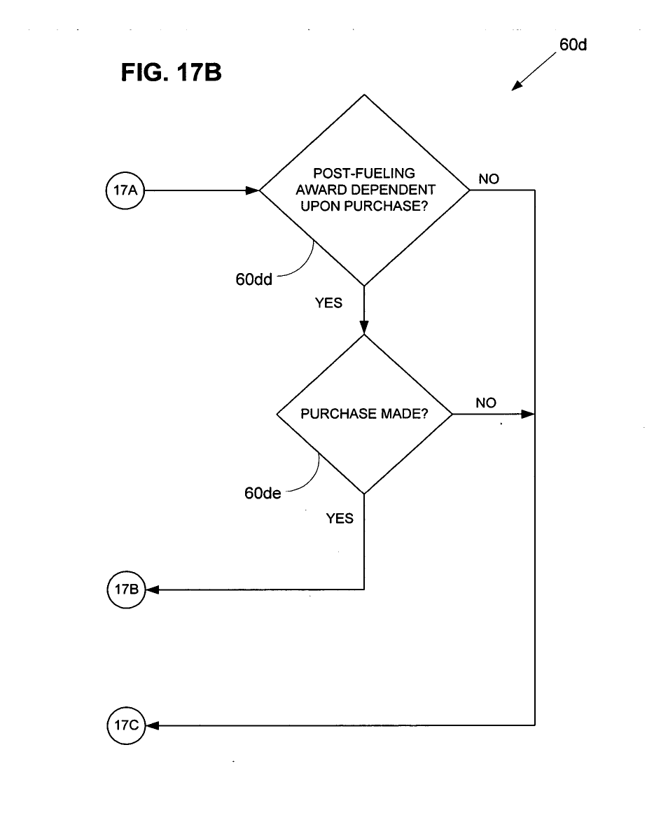

To determine the post-fueling award in the step 60d of the post-fueling marketing routine 60, as illustrated in FIGS. 17A and 17B, it is determined in step 60da whether the post-fueling award is dependent upon a minimum amount of fuel purchased by the customer at the fuel dispenser 26 and, if so, it is determined in step 60db whether the customer has purchased the minimum amount of fuel. If it is determined in the step 60da that the post-fueling award is dependent upon a minimum amount of fuel purchased by the customer and it is determined in the step 60db that the customer has purchased the minimum amount of fuel, then the post-fueling award is applied and provided to the customer in step 60dc.

If it is determined in the step 60da that the post-fueling award is not dependent upon a minimum of fuel purchased, then it is determined in step 60dd whether the post-fueling award is dependent upon a purchase made by the customer and, if so, it is determined in step 60de whether the customer has made the purchase. If it is determined in the step 60dd that the post-fueling award is dependent upon a purchase made by the customer and it is determined in the step 60de that the customer has made the purchase, then the post-fueling award is applied and provided to the customer in the step 60dc.

In several exemplary embodiments, in addition to or instead of execution of the steps 60da and 60db, and/or the steps 60dd and/or 60de, one or more other decision steps may be executed in which other forms of minimum criteria are used to determine if a post-fueling award is to be provided to the customer. For example, in exemplary embodiments where both a pre-fueling award and a post-fueling award may be applied, the minimum criteria used to determine if a post-fueling award is to be provided to the customer may be dependent upon the type of pre-fueling award applied. Other examples of minimum criteria include, for example, the particular grade of gasoline purchased by the customer such as, for example, unleaded gasoline, super unleaded gasoline, diesel gasoline or another type of premium grade fuel.

In an exemplary embodiment, the post-fueling award applied in the step 60dc may be in the form of a coupon which may be in the form of, for example, a scannable bar code, or text, printed on the receipt for payment for the fuel dispensed from the fuel dispenser 26. In another exemplary embodiment, the post-fueling award applied in the step 60dc may be in the form of a percentage discount off of the total price of the fuel that has been dispensed from the fuel dispenser 26. In another exemplary embodiment, the post-fueling award applied in the step 54bf may be in the form of a cent-per-quantity discount off of the price of the total quantity of fuel dispensed from the fuel dispenser 26. In another exemplary embodiment, the post-fueling award applied in the step 60dc may be in the form of a dollar-value discount off of the price of the fuel dispensed from the fuel dispenser 26. In another exemplary embodiment, the post-fueling award applied in the step 60dc may be in the form of a discount that is limited to a maximum dollar value such as, for example, $5.00.

In several exemplary embodiments, the post-fueling award may be in the form of, for example, any type of discount off of the price of any type of service and/or product, a credit to be applied to the price of any type of service and/or product, and/or a free service and/or product. Further, in an exemplary embodiment, the post-fueling award provided to the customer of the fuel dispenser 26, along with the at least one characteristic identified in the step 52 may be captured and stored in the computer readable medium 38, and/or may be transmitted to and captured and stored in the database 16 via the network 24 and the host computer 12.

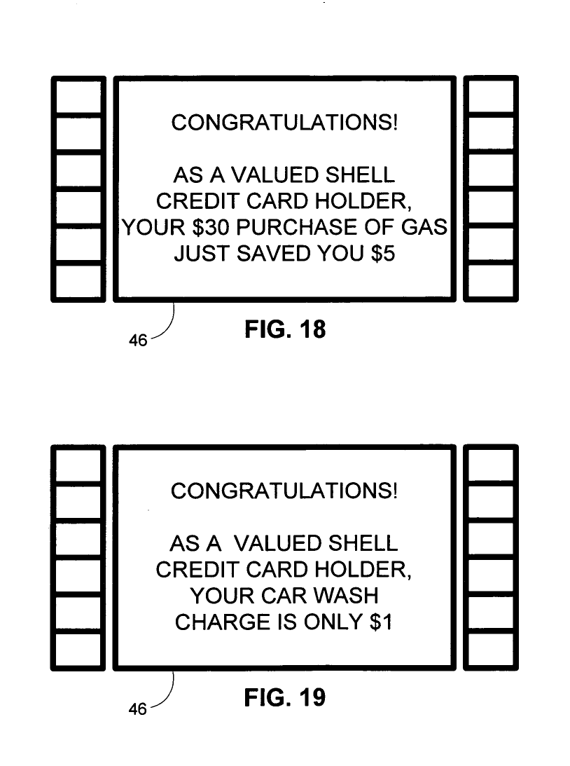

In an exemplary embodiment, as illustrated in FIG. 18, if the post-fueling award is dependent upon a minimum amount of fuel purchased as determined in the step 60da and the minimum amount of fuel is indeed purchased by the customer as determined in the step 60db, then the marketing message displayed on the display 46 in the step 60f may be in the form of a congratulatory message informing the customer of the provision of the post-fueling reward and the total amount of the discount received.

In an exemplary embodiment, as illustrated in FIG. 19, if the post-fueling award is dependent upon a purchase made by the customer as determined in the step 60dd and the purchase is indeed made by the customer as determined in the step 60de, then the marketing message displayed on the display 46 in the step 60f may be in the form of a congratulatory message informing the customer of the provision of the post-fueling reward and the discount received.

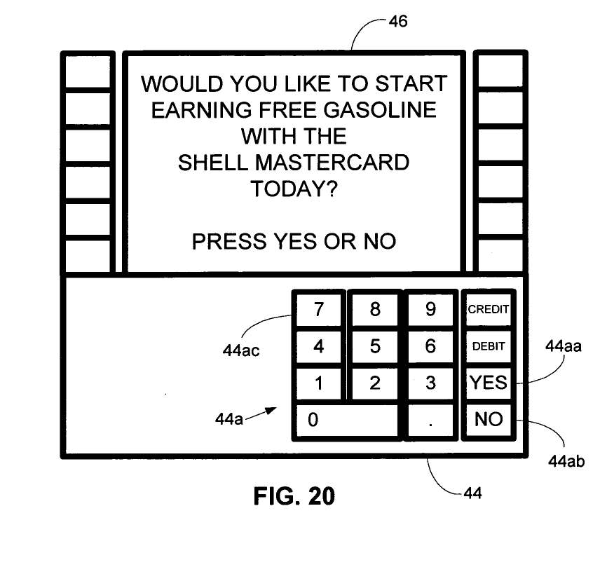

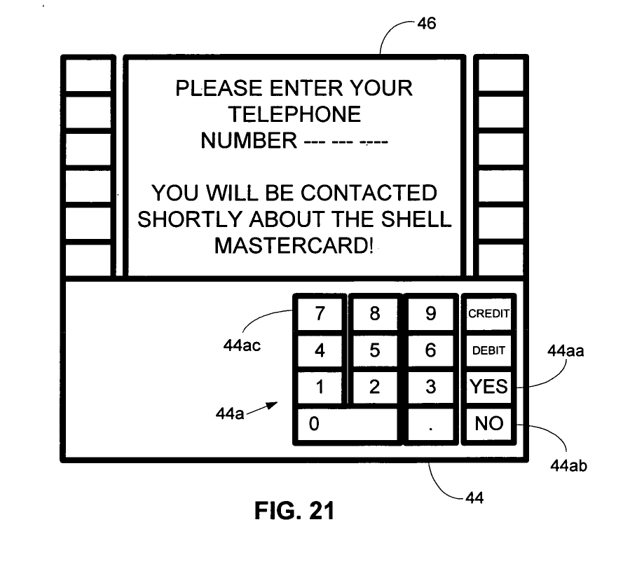

In an exemplary embodiment, as illustrated in FIGS. 20 through 21, the data interface unit 44 may include a keypad 44a having a YES key 44aa, a NO key 44ab and a plurality of numeric keys 44ac, and the soliciting of data from the customer in the step 60h may be in the form of displaying a message on the display 46 that asks if the customer would like to apply for a branded credit card, and prompts the customer to press the YES key 44aa or the NO key 44ab. If the customer presses the YES key 44aa, the soliciting of data from the customer in the step 60h may further include asking the customer to enter his or her telephone number using the plurality of numeric keys 44ac, and informing the customer that he or she will be contacted shortly about the branded credit card. The capturing of the data from the customer in the step 60i, with the data in the form of the customer's telephone number, may then be carried out by the processor 36 receiving the telephone number via the keys 44ac and the controller 40, and transmitting the telephone number for storage in the database 16 via the network 24 and the host computer 12. In an exemplary embodiment, the telephone number may also be stored in the computer readable medium 38 of the POS unit 28. After the capturing of the data in the step 60i, and in an exemplary embodiment, the customer may be called at a later time about the branded credit card via the provided telephone number.

In several exemplary embodiments, in addition to or instead of a telephone number, the data solicited in the step 60h may be in the form of a zip code, the last four digits of the customer's social security number, personal information specific to the customer such as, for example, the customer's name, mailing address, driver's license number and/or e-mail address, and/or other forms. Further, in several exemplary embodiments, in addition to or instead of asking the customer if he or she would like to apply for a branded credit card, the customer may be offered any other type of product or service and/or may be asked to provide any other type of data and/or opinion. Moreover, in several exemplary embodiments, if the customer's telephone number is captured in the step 60i, the customer may be called and offered any type of product and/or service, with the product and/or service related to and/or unrelated to the questions asked and/or the data solicited in the step 60h.

In several exemplary embodiments, before, during and/or after the execution of one or more of the pre-fueling marketing routine 54, the fueling marketing routine 58 and/or the post-fueling marketing routine 60, the attention of the customer of the fuel dispenser 26 may be drawn to the fuel dispenser 26, and any components thereof such as the display 46, in order for the customer to be aware of the execution of one or more of the marketing routines 54, 58 and 60. The attention of the customer may be drawn by, for example, generating at least one audio alert and/or generating and displaying an animated graphic on the display 46.

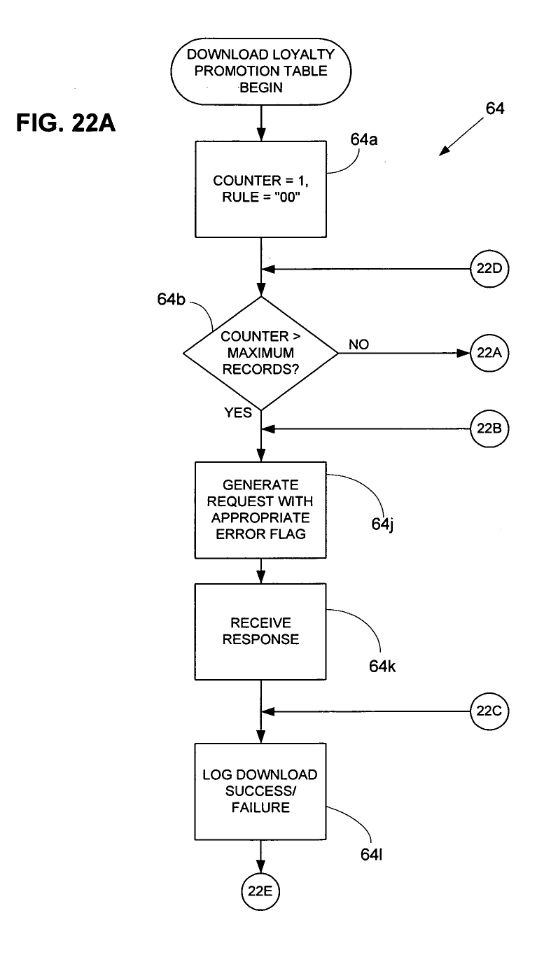

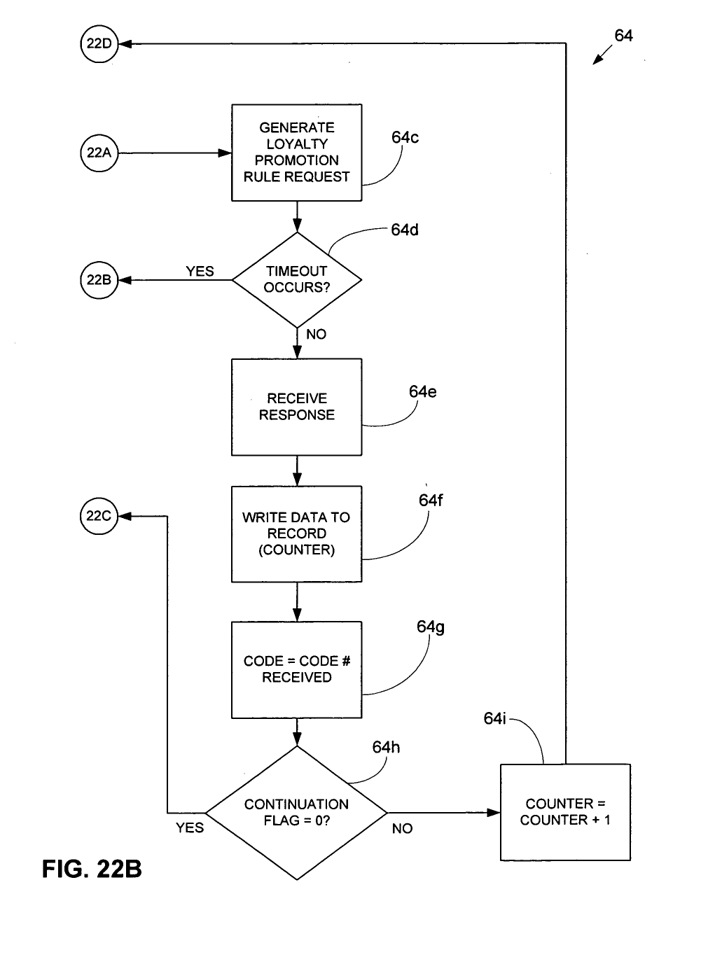

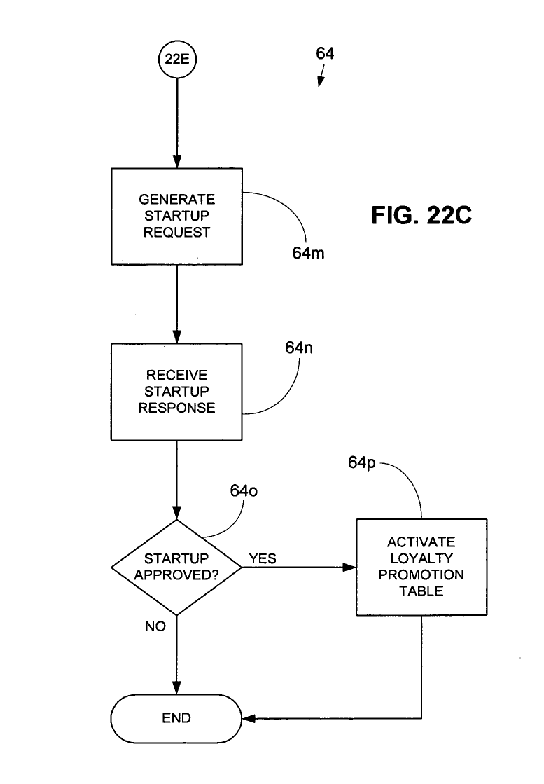

As discussed above, the host computer 12 downloads the loyalty promotion table 18 to the POS unit 28 via the network 24, so that the loyalty promotion table 18 is stored in the computer readable medium 38 and at least a portion of the operation of the fuel dispenser 26 is at least partially controlled by and dependent upon the loyalty promotion table 18. To download the loyalty promotion table 18, as illustrated in FIGS. 22A through 22C, the processor 36 executes a downloading routine 64 by executing instructions stored in the computer readable medium 38 of the POS unit 28.

A counter is initialized to one and the promotion rule is initialized to “00” in step 64a. It is then determined in step 64b whether the counter is greater than the maximum number of records that the loyalty promotion table 18 is supposed to contain when stored in the computer readable medium 38. If the counter is determined in the step 64b to not be greater than the maximum number of records that the loyalty promotion table 18 is supposed to contain when stored in the computer readable medium 38, a loyalty promotion rule request is generated by the processor 36 and transmitted to the host computer 12 via the network 24 in step 64c.

It is then determined in step 64d whether a timeout occurs and, if no timeout occurs, the processor 36 receives a response back from the host computer 12 in step 64e. The processor 36 then writes data to the computer readable medium 38 in step 64f, with the data corresponding to the promotion rule supplied by the host computer 12 in its response, thereby forming a single record in the loyalty promotion table 18 as stored in the computer readable medium 38. Thus, the promotion rule is in the form of data which, in turn, forms a record in the loyalty promotion table 18, as stored in the computer readable medium 38. A record number is defined for the record and corresponds to the current counter setting. For example, the number of record no. 1 of the loyalty promotion table 18 corresponds to the counter setting one, as initialized in the step 64a, and the content of record no. 1, as stored in the computer readable medium 38, corresponds to the response received in the step 64e in response to the first execution of the step 64c.

In step 64g, the promotion code for the record is set as the code number received in the response in the step 64e. In an exemplary embodiment, the code may be in a form other than a numeric form such as, for example, in an alphanumeric form.

It is next determined in step 64h whether to continue with the download of the loyalty promotion table 18 by using continuation flag logic and determining whether the continuation flag in the message header transmitted by the host computer 12 in its response in the step 64e is equal to zero. If the continuation flag is not equal to zero, the counter is incremented by one in step 64i and the step 64b is repeated to determine if the counter is greater than the maximum number of records, as discussed above. The steps 64b, 64c, 64d, 64e, 64f, 64g, 64h and 64i may then be repeated as discussed above with the incremented counter.

The loop created by the steps 64b, 64c, 64d, 64e, 64f, 64g, 64h and 64i is repeated until the current counter is greater than the maximum number of records that the loyalty promotion table 18 is supposed to contain when stored in the computer readable medium 38, as determined in the step 64b, or when a timeout occurs in the step 64d, or when the continuation flag equals zero, as determined in the step 64h.

If the current counter is greater than the maximum number of records that the loyalty promotion table 18 is supposed to contain when stored in the computer readable medium 38, as determined in the step 64b, or if a timeout occurs as determined in the step 64d, then a request with an appropriate error flag is generated in step 64j and a response to the request is received from the host computer 12 in step 64k.

After the response is received from the host computer 12 in the step 64k, or when it is determined in the step 64h that the continuation flag in the message header transmitted by the host computer 12 is equal to zero, the success or failure of the download of the loyalty promotion table 18 to the computer readable medium 38 is logged in step 641 and a startup request is generated in step 64m. The response to the startup request is received from the host computer 12 in step 64n and it is determined whether the startup of the loyalty promotion table 18 has been approved in step 640. If the startup is approved in the step 640, then the loyalty promotion table 18 stored in the computer readable medium 38 is activated in step 64p.

In an exemplary embodiment, the activation of the loyalty promotion table 18 in the step 64p replaces any existing loyalty promotion table currently stored in the computer readable medium 38 of the POS unit 28.

In several exemplary embodiments, the downloading routine 64 may be executed at one or more predetermined times. For example, the downloading routine 64 may be executed in time increments such as, for example, once a week. In an exemplary embodiment, in addition to or instead of the computer readable medium 14, all or portions of the database 16, including the loyalty promotion table 18, may be downloaded from any computer readable medium or memory that is accessible to the host computer 12 and/or to any other device in communication with the POS unit 28. Further, in an exemplary embodiment, in addition to or instead of the computer readable medium 38, all or portions of the database 16, including the loyalty promotion table 18, may be downloaded to any computer readable medium or memory that is accessible to the processor 36 and/or to any other device in communication with the fuel dispenser 26.

In several exemplary embodiments, different versions of the loyalty promotion table 18 may be downloaded to the one or more POS units in the system 10 so that the version of the loyalty promotion table 18 downloaded to the POS unit 28 may differ from, or be identical to, the versions of the loyalty promotion table 18 downloaded to one or more of the other POS units in the system 10 such as, for example, the POS unit 34. In an exemplary embodiment, the criteria for the POS unit 28 receiving a predetermined version of the loyalty promotion table 18 may include, for example, the location of the POS unit 28, the type of platform of the POS unit 28, the type of fuel dispenser 26 including, but not limited to, the type of dispensing equipment 48, the system equipment and/or capabilities of the POS system 20, the market in which the POS system 20 is located, the country, state, city or other type of jurisdiction in which the POS system 20 is located, the buying area associated with the POS system 20, the demographics of the geographic area in which the POS system 20 is located, and/or the language or languages spoken in the geographic area in which the POS system 20 is located. In several exemplary embodiments, other tables, databases and/or instructions may be downloaded to the POS unit 28 from the host computer 12 via the network. Examples of other tables include, but are not limited to, an issuer table for identifying payment types such as, for example, identifying credit card types that may be accepted as valid payment types or not accepted as valid payment types, a range table for identifying sequences of subsets of the payment types identified in the issuer table such as, for example, sequences of credit card numbers that may be included as valid payment types or that may be excluded as invalid payment types, and/or other types of tables that control other features and/or steps of the system 10 and/or the method 50.

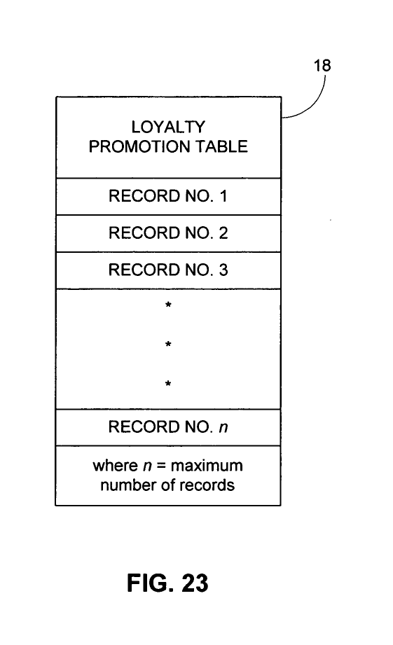

In an exemplary embodiment, as illustrated in FIG. 23, the loyalty promotion table 18, as stored in the computer readable medium 38 of the POS unit 28, includes a plurality of records, with each record being equivalent to a single loyalty promotion rule. That is, determining the promotion rule in the step 54a of the pre-fueling marketing routine 54 corresponds to identifying a particular record of the loyalty promotion table 18 and determining the contents therein.

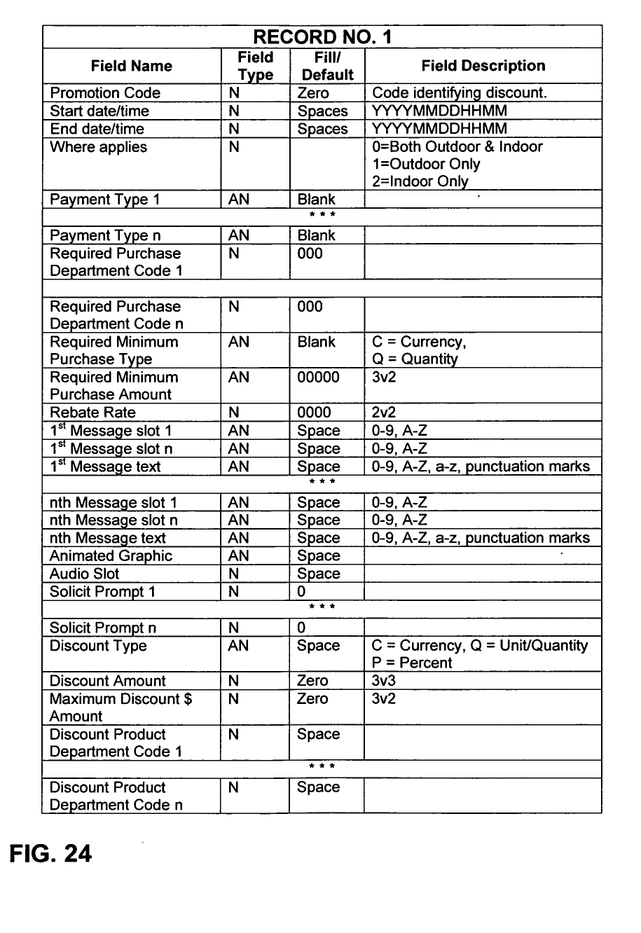

In an exemplary embodiment, as illustrated in FIG. 24, each record such as, for example, record no. 1, includes a plurality of data fields including a promotion-code field for identifying the group and/or local discount, and which corresponds to the promotion code determined in the step 54aj of the pre-fueling marketing routine 54. Start-date/time and end-date/time fields are used to define the active time period that the group and/or local discount is valid, and are used to determine if the current date and time corresponding to the use of the fuel dispenser 26 by the customer is correct in the step 54ag of the pre-fueling marketing routine 54. A where-applies field is used to specify the location to which the group and/or local discount applies, and is used to determine if the location associated with the use of the fuel dispenser 26 by the customer is correct in the step 54ah of the pre-fueling marketing routine 54.

Payment-type fields 1 through n, with n being the maximum number of payment types accommodated, are used to restrict the group and/or local discount to a particular payment type or types, and are used to determine if the payment type used by the customer of the fuel dispenser 26 is correct in the step 54ai of the pre-fueling marketing routine 54. Required-purchase-department-code fields 1 through n, with n being the maximum number of purchase codes accommodated, are used to indicate that a particular type of product and/or department of products must be purchased in the transaction before a post-fueling award applies, and are used to determine if the post-fueling award is dependent upon a purchase in the step 60dd.

A required-minimum-purchase-type field is used to specify if a minimum quantity of a product must be purchased by the customer of the fuel dispenser 26 or if the purchase must have a minimum dollar value in order to trigger a post-fueling award, and is used to determine if the post-fueling award is dependent upon a minimum amount of fuel purchased in the step 60da. A required-minimum-purchase-amount-type field is used to determine if the minimum purchase has been made to trigger the post-fueling award, and is used to determine if the minimum amount of fuel has been purchased in the step 60db.

Fields 1^{st}-Message-slot-1 through 1^{st}-Message-slot-n are used to indicate which pre-defined slots the 1^{st} marketing message is assigned to be displayed in, with the slots corresponding to possible assignments in the step 54c of the pre-fueling marketing routine 54, the step 58a of the fueling marketing routine 58 and/or the steps 60b and/or 60e of the post-fueling marketing routine 60. In several exemplary embodiments, additional slots may be implemented such as, for example, slots for determining whether marketing messages are assigned to be printed on a receipt. The term n in the 1^{st}-Message-slot-n field corresponds to the maximum number of slots to which the 1^{st} Message is assigned. A 1^{st}-Message-text field contains the marketing message to be displayed in the slots specified in the fields 1^{st}-Message-slot 1 through 1^{st}-Message-slot n.

Fields nth-Message-slot 1 through nth-Message-slot n are used to indicate which pre-defined slot the nth marketing message is assigned to be displayed in, with the slots corresponding to possible assignments in the step 54c of the pre-fueling marketing routine 54, the step 58a of the fueling marketing routine 58 and/or the steps 60b and/or 60e of the post-fueling marketing routine 60. In several exemplary embodiments, additional slots may be implemented such as, for example, slots for determining whether marketing messages are assigned to be printed on a receipt. The term nth in the nth-Message-slot 1 through the nth-Message-slot n fields corresponds to the nth marketing message to be displayed such as, for example, the 6^{th} marketing message to be displayed in one or more slots, that is, the 6^{th} marketing message that is assigned in one or more of the steps 54c, 58a, 60b and/or 60e.

A 1^{st}-Message-text field contains the marketing message to be displayed in the slots specified in the fields 1^{st}-Message-slot 1 through 1^{st}-Message-slot n. An nth-Message-text field contains the marketing message to be displayed in the slots specified in the fields nth-Message-slot 1 through nth-Message-slot n. The 1^{st} through nth Messages are then displayed during the execution of one or more of the steps 54d, 58b, 60c and/or 60f.

An animated-graphic field and an audio-alert field indicates whether an animated graphic and an audio alert, respectively, are to be generated to draw the customer's attention to the fuel dispenser 26, and which pre-loaded animated graphic and audio alert, respectively, are to be generated.

Solicit-prompt 1 through solicit-prompt n fields allow for the configuration of customer data solicitation prompts to be activated during the step 60h of the post-fueling marketing routine. Solicit-prompt 1 field may prompt for one type of data such as a telephone number, and solicit-prompt n field may prompt for another type of data such as a zip code.

A discount-type field indicates the type or form of pre-fueling or post-fueling award to apply to the customer of the fuel dispenser 26, and a discount-amount field indicates the value of the discount to apply. The discount-type and discount-amount fields are used in the steps 54ad, 54ba, 54bb, 54bc, 54bd, 54be, 54bf and/or other steps of the pre-fueling marketing routine 54 and/or the step 60dc and/or other steps of the post-fueling marketing routine 60. A maximum-discount-$-amount field specifies the maximum possible dollar value of any discount applied in the steps 54ad, 54bc, 60dc and/or other steps of the method 50.

Discount-product-department-code 1 through discount-product-department code n fields are used to indicate which products are eligible for discount. In several exemplary embodiments, the content of the discount-product-department-code 1 field may be the same as or different than the content of the required-purchase-department-code 1 field. For example, the required-purchase-department-code 1 field may require the customer of the fuel dispenser to purchase a particular grade of gasoline such as, for example, unleaded gasoline, super unleaded gasoline, diesel gasoline or another type of premium grade fuel, and the discount-product-department code may dictate that any discount is to be applied against the cost of a car wash. In several exemplary embodiments, the product, and/or range or ranges of products, eligible for discount may include, but are not limited to, any product and/or service that may be purchased at the fuel dispenser 26, and/or that may be purchased at a location other than the location of the fuel dispenser 26. As shown in FIG. 24, each of the fields have a field type of N, that is, a numeric field type, or have a field type of AN, that is, an alphanumeric field type. Moreover, each of the fields have a numeric fill/default or an alphanumeric fill/default.

In several exemplary embodiments, one or more fields may be omitted from one or more records of the loyalty promotion table 18, and/or that additional fields may be included in one or more records in the loyalty promotion table 18. These other fields may include one or more of the following: one or more additional discount-type and discount-amount fields, a rebate-rate field, a discount-receipt-descriptor field for specifying text to be included on the receipt to describe the pre-fueling and/or post-fueling awards, a pre-fueling-message-time field to specify the length of time to display a marketing message in the step 54d of the pre-fueling marketing routine 54, a discount-department-code field to identify the value of the pre-fueling and/or post-fueling awards in order to enable back-end settlement with the retailer and/or third parties, a fueling-message-time field to specify the length of time to display a marketing message in the step 58b of the fueling marketing routine 58, and a post-fueling-message-time field to specify the length of time to display a marketing message in the step 60c and/or 60f of the post-fueling marketing routine 60.

Also, in several exemplary embodiments, additional reward-criteria fields for determining whether a pre-fueling and/or post-fueling reward is available to the customer of the fuel dispenser may be included in one or more records in the loyalty promotion table 18, in addition to or instead of the above-described award-criteria fields, which include the start-date/time field, the end-date/time field, the where-applies field, the payment-type fields 1 through n, the required-purchase-department-code fields 1 through n, the required-minimum-purchase-type field, the required-minimum-purchase-amount-type field and the discount-product-department code fields 1 through n. Additional award-criteria fields include, for example, a particular account-holder field for identifying one or more account holders of a particular payment type such as, for example, one or more account holders of a third party credit card. Moreover, in several exemplary embodiments, the quantity of any of the award-criteria fields of the loyalty promotion table 18 may be increased or decreased, and that the quantity of any of the other above-described fields of the loyalty promotion table 18 may be increased or decreased.

Moreover, in several exemplary embodiments, one or more additional fields may be added to one or more records of the loyalty promotion table 18 and that these one or more additional fields may each be any type of field. In several exemplary embodiments, one or more of the fields in one or more of the records may be unpopulated.

In several exemplary embodiments, the operation of the POS system 22, and of any other POS systems that may be included in the system 10, is substantially identical to the operation of the POS system 20 and therefore will not be described in detail.

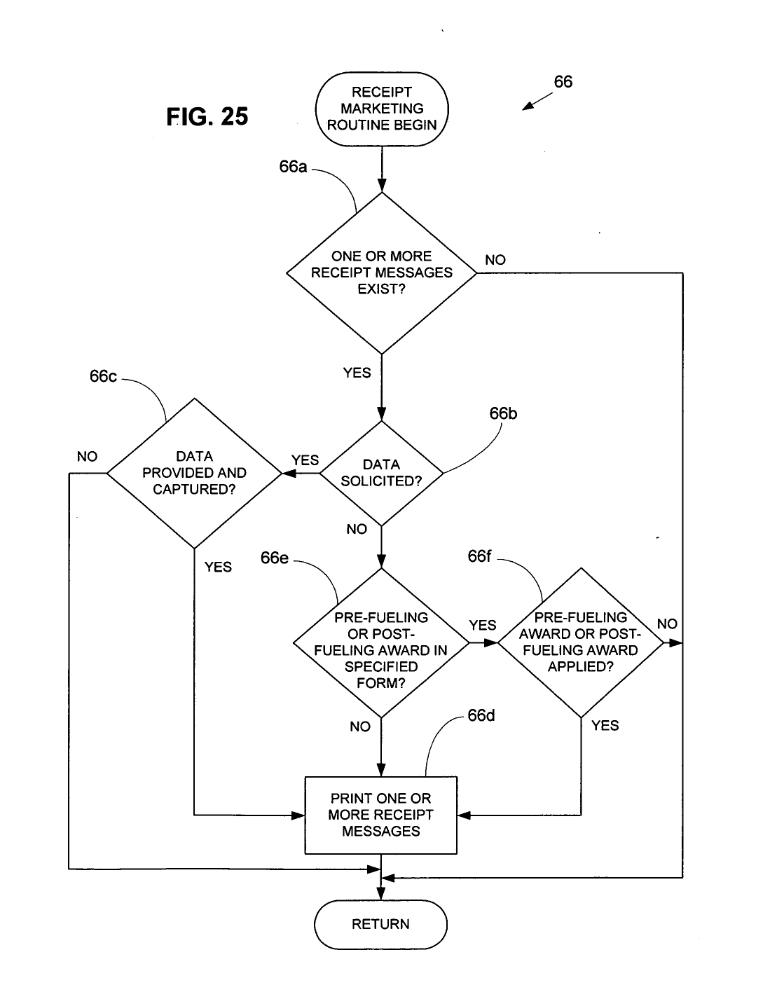

In an exemplary embodiment, as illustrated in FIG. 25, a receipt marketing routine is executed in step 66 after the post-fueling marketing routine is executed in the step 60 of the method 50. In an exemplary embodiment, a settlement routine and/or a receipt routine may be executed after the post-fueling marketing routine is executed in the step 60 and before the receipt marketing routine is executed in the step 66. In an exemplary embodiment, the receipt marketing routine executed in the step 66 may be at least partially dependent upon the characteristic identified in the step 52.

To execute the receipt marketing routine in the step 66, as illustrated in FIG. 25, it is determined whether one or more receipt messages exist in step 66a. In an exemplary embodiment, the population of one or more discount-receipt-descriptor fields, for specifying text to be included on the receipt to describe, for example, the pre-fueling and/or post-fueling awards, in the corresponding record in the loyalty promotion table 18 may be used to determine that one or more receipt messages exist in the step 66a. Conversely, the absence of the population of one or more discount-receipt-descriptor fields in the corresponding record in the loyalty promotion table 18 may be used to determine that one or more receipt messages do not exist in the step 66a.

If one or more receipt messages do exist as determined in the step 66a, it is determined in step 66b whether data was solicited in the step 60h and, if so, it is determined in step 66c whether the data was provided and captured in the step 60i. If the data was provided and captured in the step 60i, the one or more receipt messages are printed on the receipt in step 66d, thereby communicating one or more marketing messages to the customer. In an exemplary embodiment, the one or more receipt messages printed in the step 66d may comprise, for example, a thank-you or congratulatory message to the customer in response to the customer's provision of the solicited data, and/or one or more other marketing messages that may be, for example, related to whether a pre-fueling marketing award was applied in the step 54bc or 54bf, and/or at least partially dependent upon the characteristic identified in the step 52.

If it is determined in the step 66b that data was not solicited in the step 60h, it is determined in step 66e whether the pre-fueling award or the post-fueling award is in a specified form, including whether the pre-fueling award or the post-fueling award is in the form of a percentage discount, cent-per-quantity discount, or currency or dollar-value discount, as described above.

If it is determined in the step 66e that the pre-fueling award or the post-fueling award is in the specified form, it is determined in step 66f whether the pre-fueling award was applied in the steps 54bf or 54bc, or whether the post-fueling award was applied in the step 60dc and, if either was applied, the one or more receipt messages are printed on the receipt in the step 66d, thereby communicating one or more marketing messages to the customer. In an exemplary embodiment, the one or more receipt messages printed in the step 66d may comprise, for example, one or more informational or congratulatory messages informing the customer of the application of the pre-fueling award or the post-fueling award, and/or one or more other marketing messages that may be, for example, at least partially dependent upon the characteristic identified in the step 52. If it is determined in the step 66e that the pre-fueling award or post-fueling award is not in the specified form, the one or more receipt messages are printed in the step 66d and may be, for example, at least partially dependent upon the characteristic identified in the step 52.

In an exemplary embodiment, the steps 66e and 66f may be omitted from the receipt marketing routine executed in the step 66. As a result, if it is determined in the step 66b that data was not solicited in the step 60h, the one or more receipt messages may be printed on the receipt, regardless of the form of the pre-fueling or post-fueling awards or whether the pre-fueling or post-fueling awards were applied.

In an exemplary embodiment, a receipt may be printed after the receipt marketing routine is executed in the step 66, even if the one or more receipt messages are not printed on the receipt.

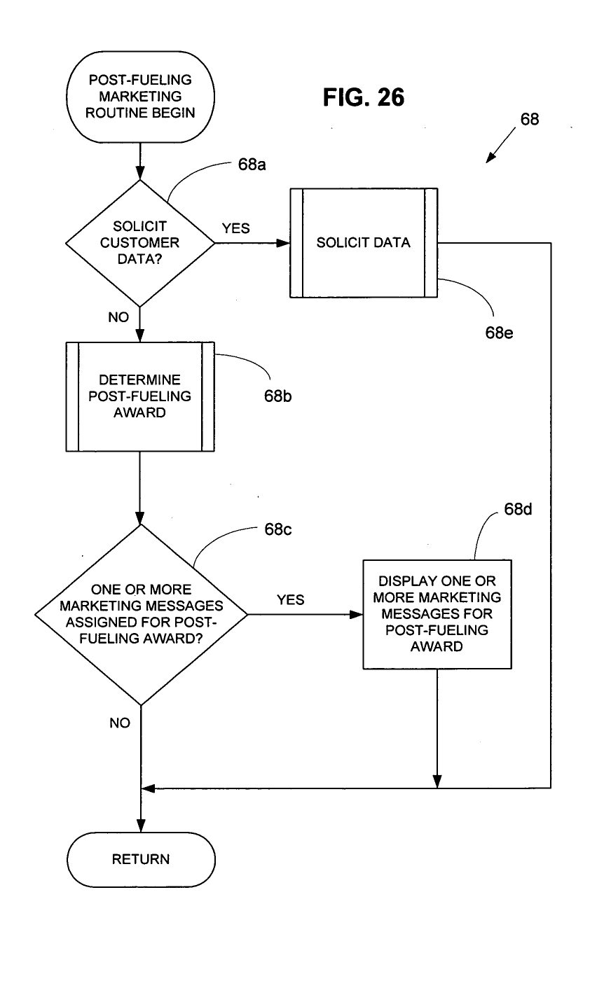

In an exemplary embodiment, as illustrated in FIG. 26, instead of, or in addition to executing the post-fueling marketing routine in the step 60, a post-fueling marketing routine may be executed in step 68 after executing the fueling marketing routine in the step 58.

To execute the post-fueling marketing routine in the step 68, as illustrated in FIG. 26, it is determined in step 68a whether data is to be solicited from the customer. If not, the post-fueling award is determined in step 68b, which is substantially identical to the step 60d, described above, and therefore the step 68b will not be described in further detail. After the step 68b, it is determined in step 68c whether one or more marketing messages are assigned for the post-fueling award and, if so, one or more marketing messages for the post-fueling award are displayed via the display 46 in step 68d. If it is determined in the step 68a that data is to be solicited from the customer, data is solicited in step 68e.

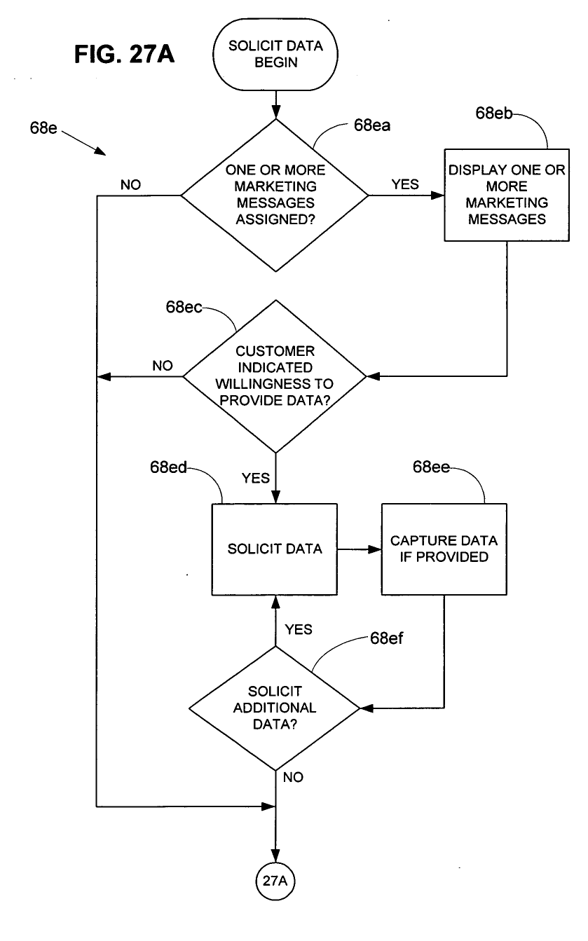

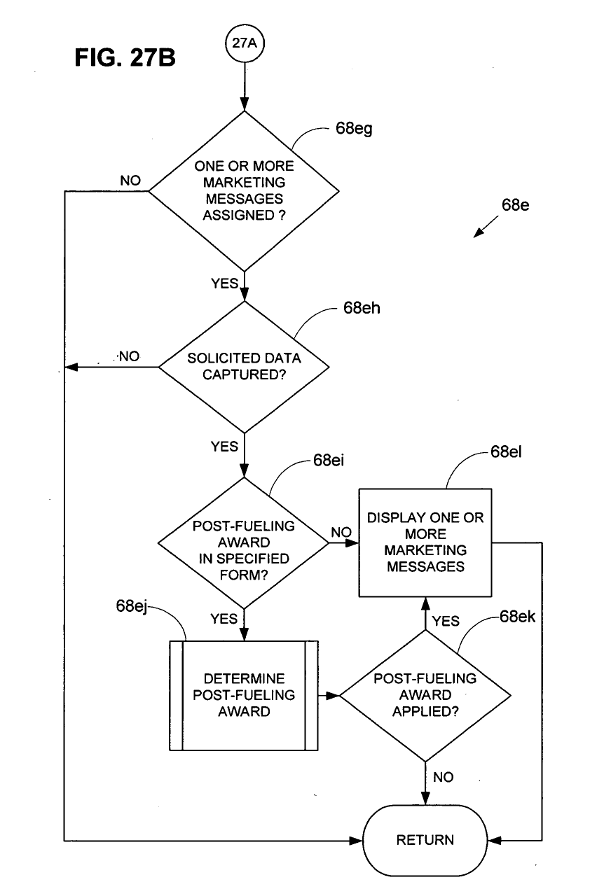

In an exemplary embodiment, as illustrated in FIGS. 27A and 27B, to solicit data in the step 68e, it is determined in step 68ea whether one or more marketing messages are assigned. If so, the one or more marketing messages are displayed via the display 46 in step 68eb, with at least one of the one or more marketing messages requesting that the customer indicate whether he or she is willing to provide data. It is next determined in step 68ec whether the customer has indicated a willingness to provide data and, if so, data is solicited in step 68ed. In an exemplary embodiment, the customer may indicate a willingness to provide data by pressing the YES key 44aa on the keypad 44a, in response to at least one of the one or more marketing messages displayed in the step 68eb.

After soliciting data in the step 68ed, the data, if provided, is captured in step 68ee. It is determined in step 68ef whether additional data is to be solicited and, if so, the steps 68ed and 68ee are repeated. The steps 68ed, 68ee and 68ef are repeated until it is determined in the step 68ef that no more data is to be solicited.

If no more data is to be solicited as determined in the step 68ef, or if the customer did not indicate a willingness to provide data in the step 68ec, or if one or more marketing messages were not assigned as determined in the step 68ea,it is next determined in step 68eg whether one or more marketing messages are assigned. If so, it is determined in step 68eh whether data was provided and captured in the step 68ee and, if so, it is determined in step 68ei whether the post-fueling award, if it is to be applied, is in a specified form, including whether the post-fueling award is to be in the form of a percentage discount, cent-per-quantity discount, or currency or dollar-value discount, as described above. In an exemplary embodiment, the step 68ei may be executed by determining the content of the discount-type field in the corresponding record in the loyalty promotion table 18.

If the post-fueling award is to be in the form of a percentage discount, cent-per-quantity discount, or currency or dollar-value discount, as determined in the step 68ei, the post-fueling award is determined in step 68ej, which is substantially identical to the step 60d, described above, and therefore the step 68ej will not be described in further detail. It is next determined in step 68ek whether the post-fueling award was applied and, if so, one or more marketing messages are displayed via the display 46 in step 68el, and may, for example, comprise one or more marketing messages related to the application of the post-fueling award. If the post-fueling award is not to be in the form of a percentage discount, cent-per-quantity discount, or currency or dollar-value discount, as determined in the step 68ei, then one or more marketing messages are displayed via the display 46 in the step 68el.

In several exemplary embodiments, the POS unit 28, the POS unit 34 and/or any additional POS units in the system 10 may each be in the form of a wide variety of point-of-sale systems such as, for example, a wide variety of electronic-point-of-sale (EPOS) systems and/or platforms such as, for example, Gilbarco™G-Site™, Gilbarco™Passport™, VeriFone™ Topaz™, MSI™CVN™, Radiant™, VeriFone™ Omni 3300™, VeriFone™ Ruby™ and/or VeriFone™ Ruby/Sapphire™ systems and/or platforms.

In several exemplary embodiments, the system 10 may be deployed in a rollout to all markets for invested sites, and/or a rollout to all markets for Wholesaler and/or Open Dealer sites. In several exemplary embodiments, the number of possible message slots and/or assignments in the above-described method 50, the pre-fueling marketing routine 54, the fueling marketing routine 58, the post-fueling marketing routine 60 and/or the loyalty-promotion table 18 and all versions thereof may be increased or decreased as desired and/or as necessary. Moreover, in several exemplary embodiments, the number of possible messages in the above-described method 50, the pre-fueling marketing routine 54, the fueling marketing routine 58, the post-fueling marketing routine 60 and/or the loyalty-promotion table 18 and all versions thereof may be increased or decreased as desired and/or as necessary. Also, in several exemplary embodiments, any provided coupon may be, for example, printed as a scannable bar code on a receipt, or as text on a receipt. In several exemplary embodiments, the determination as to whether the pre-fueling award and/or the post-fueling award has been applied, as executed in, for example, the steps 60a, 66f and/or 68ek, may comprise determining whether one or more flags such as, for example, one or more reward flags, have been set to true in response to the application of the pre-fueling award and/or the post-fueling award in one or more of the above-described routines. In several exemplary embodiments, the determination as to whether data has been captured, as executed in, for example, the steps 66c and/or 68eh, may comprise determining whether one or more flags such as, for example, one or more reward flags, have been set to true in response to the capturing of data in one or more of the above-described routines.

In several exemplary embodiments, card-holder-specific awards may be provided for multiple payment card types. Moreover, a single card-holder-specific award may be applied to multiple payment card types, or multiple card-holder-specific awards may be applied to one or more payment card types. Further, the above-described local discounts, group discounts, pre-fueling awards and/or post-fueling awards may each be based on a qualifying number of purchases. For example, a customer may purchase a particular product and/or service three times and, in response, receive a pre-fueling, post-fueling and/or other type of reward.

In several exemplary embodiments, additional customer prompts may be implemented. For example, additional customer prompts may be implemented for acquiring new cardholders for a proprietary credit card such as the Shell™ Proprietary Card and/or a branded credit card such as the Shell™ Mastercard™.

In several exemplary embodiments, one or more components of the system 10 may interface with Experian™ and/or Citibank™ for instant credit approval for any type of payment such as, for example, a proprietary credit card such as the Shell™ Proprietary Card and/or a branded credit card such as the Shell™ Mastercard™. For example, the host computer 12, the POS unit 28, the POS unit 34 and/or the controller 40 may interface with Experian™ and/or Citibank™.

In several exemplary embodiments, the system 10 and/or the method 50 may support dual swipe loyalty from potential partners such as, for example, airline or grocery partners. For example, the system 10 may include other POS systems that are not coupled to fuel dispensers or used in fuel-dispensing environments, and instead are used in other environments such as, for example, grocery stores. For another example, one or more components of the system 10, such as the dispenser card reader 42, may read, identify data from and/or locate data associated with grocery store reward cards and/or frequent-flyer reward cards, in addition to or instead of payment cards. In several exemplary embodiments, group discounts, local discounts, pre-fueling awards, post-fueling awards and/or other type of rewards may be in response to the use of the grocery store reward cards and/or frequent-flyer reward cards.

In several exemplary embodiments, the system 10 and/or the method 50 may support multi-site sweepstakes promotions with sweepstakes numbers printed on receipts, and with random automated selection of winners. In an exemplary embodiment, data and/or data fields associated with the sweepstakes promotions may be stored in one or more versions of the loyalty promotion table 18. In an exemplary embodiment, one or more group discounts, local discounts, pre-fueling awards, post-fueling awards and/or other types of rewards may be associated with sweepstakes promotions. In an exemplary embodiment, the random automated selection of winners in a sweepstakes promotions may be limited to customers that are holders of one or more payment card types such as, for example, proprietary credit card holders and/or branded credit card holders.

In several exemplary embodiments, a wide range of modifications may be made to one or more of the fuel dispensers in the system 10. For example, the interface methods and/or components used therein between a customer and a fuel dispenser may be modified to provide more user control over fueling interaction. For example, the data interface unit 44 and/or the display 46 may be modified and/or combined to provide a graphical user interface via which the customer may enter data to be stored, processed and/or transmitted by one or more components of the system 10, and via which the customer may customize an interface between himself or herself and the fuel dispenser. Examples of customization include the customer customizing a personal web site that may be viewed over the display 46, with the web site providing links and/or content related to the customer's previously-selected and/or previously-indicated interests, selecting one or more television and/or radio networks the content programming of which may be viewed over the display 46, accessing one or more e-mail accounts, accessing the Internet including the World Wide Web. Further examples of customization include automatically selecting the particular grade of fuel that the customer has previously selected as his or her preferred grade of fuel, providing an audio greeting to the customer in which the customer's name is announced and/or other messages are communicated to the customer.

In several exemplary embodiments, one or more of the POS systems in the system 10 such as, for example, the POS system 20 and/or 22, may interface to one or more changeable Mastercard™ earnings controllers. In several exemplary embodiments, instead of, or in addition to displaying the one or more marketing messages on the display 46 in one or more of the steps 54d, 58b, 60c and/or 60f, the one or more marketing messages may be communicated to the customer via a wide variety of multimedia and/or multimedia techniques such as, for example, via the printing of the one or more marketing messages on a coupon and/or other type of paper, via the playing of audio recordings of the one or more marketing messages over an audio speaker coupled to the fuel dispenser 26, and/or via any other type of multimedia and/or tangible medium including, but not limited to, any type of audio media, any type of print media, any type of video or visual media and/or any combination thereof.

In several exemplary embodiments, one or more of the above-described steps of the method 50 may be carried out using one or more intermediaries between the customer of the fuel dispenser 26, 30 or 32 and the fuel dispenser 26, 30 or 32. For example, if the fuel dispenser 26, 30 or 32 is located at a full-service site, the method 50 may be carried out via the human operator of the fuel dispenser 26, 30 or 32.

In several exemplary embodiments, in addition to, or instead of the fuel dispenser 26, the POS unit 28 may be operably coupled to another device such as, for example, a keyboard, a card reader, a pin pad, a computer, a scanner and/or a kiosk such as, for example, a car-wash kiosk or a lottery kiosk. A customer of such a device that is operably coupled to the POS unit 28 may use the device to, for example, purchase goods and/or services. In several exemplary embodiments, in addition to, or instead of the fuel dispensers 30 and 32, the POS unit 34 may be operably coupled to another device such as, for example, a keyboard, a card reader, a pin pad, a computer, a scanner and/or a kiosk such as, for example, a car-wash kiosk or a lottery kiosk. A customer of such a device that is operably coupled to the POS unit 34 may use the device to, for example, purchase goods and/or services.

In several exemplary embodiments, one or more of the above-described portions of the system 10 and/or one or more of the above-described steps of the method 50 may provide for active marketing and/or promotion of products and/or services during the operation of one or more of the fuel dispensers 26, 30 and 32, including, but not limited to, the rewarding, the communicating of marketing messages to and/or the soliciting of data from customers of the fuel dispensers 26, 30 and/or 32. Among other results of the active marketing and/or promotion, products and/or services may be promoted to the customers, the customers of the fuel dispensers 26, 30 and/or 32 may become customers of other products and/or services, and/or the loyalty of one or more of the customers of the fuel dispensers 26, 30 and/or 32 may be increased, enhanced and/or reinforced. Moreover, the active marketing and/or promotion of products and/or services to a particular customer may be in response to at least one identifying characteristic provided by the particular customer. The active marketing and/or promotion of products and/or services may be provided without requiring any type of appreciable modification to either an existing or new fuel dispenser and/or components and/or systems coupled thereto.

From September 2005 to March 2006, experimental market testing was conducted using experimental embodiments of the system 10 and experimental embodiments of the method 50. The experimental market testing was conducted at about 60 fuel-dispensing sites in several markets in the United States of America, including Houston, Tex.; Dallas, Tex.; Las Vegas, Nev.; Denver, Colo.; Colorado Springs, Colo.; San Francisco, Calif.; San Diego, Calif.; Boise, Id.; Nashville, Tenn.; and Washington, D.C.

During at least a portion of the experimental market testing, the experimental use of an embodiment of the system 10, and the experimental use of an embodiment of the method 50, resulted in an approximate three-fold increase in Shell™ branded credit card applications, when compared to roughly equivalent historical data for roughly equivalent time periods at roughly equivalent fuel-dispensing sites in roughly equivalent markets. This was an unexpected experimental result.

During at least a portion of the experimental market testing, the experimental use of an embodiment of the system 10, and the experimental use of an embodiment of the method 50, resulted in an approximate two-fold increase in low-level activity Shell™ branded credit card accounts, when compared to roughly equivalent historical data for roughly equivalent time periods at roughly equivalent fuel-dispensing sites in roughly equivalent markets. This was an unexpected experimental result.

During at least a portion of the experimental market testing, the experimental use of an embodiment of the system 10, and the experimental use of an embodiment of the method 50, resulted in an approximate 200% increase in activity rate among inactive Shell™ branded credit card accounts, when compared to roughly equivalent historical data for roughly equivalent time periods at roughly equivalent fuel-dispensing sites in roughly equivalent markets. This was an unexpected experimental result.

During at least a portion of the experimental market testing, the experimental use of an embodiment of the system 10, and the experimental use of an embodiment of the method 50, resulted in an approximate two-fold increase in the purchase of Shell V-Power™ premium-grade fuel, when compared to roughly equivalent historical data for roughly equivalent time periods at roughly equivalent fuel-dispensing sites in roughly equivalent markets. This was an unexpected experimental result.

During at least a portion of the experimental market testing, the experimental use of an embodiment of the system 10, and the experimental use of an embodiment of the method 50, resulted in an approximate two-fold increase in car-wash purchases, auto-care product purchases, and convenience-store product purchases, when compared to roughly equivalent historical data for roughly equivalent time periods at roughly equivalent fuel-dispensing sites in roughly equivalent markets. This was an unexpected experimental result.

During at least a portion of the experimental market testing, the experimental use of an embodiment of the system 10, and the experimental use of an embodiment of the method 50, resulted in an approximate two-fold increase in debit-card payment pin transactions, when compared to roughly equivalent historical data for roughly equivalent time periods at roughly equivalent fuel-dispensing sites in roughly equivalent markets, thereby lowering merchant fees for the retailers who own and/or manage the fuel-dispensing sites. This was an unexpected experimental result.

A method of operating a fuel dispenser has been described that includes identifying at least one characteristic specific to a customer of the fuel dispenser; and executing one or more marketing routines; wherein at least one of the one or more marketing routines is at least partially dependent upon the at least one characteristic specific to the customer of the fuel dispenser. In an exemplary embodiment, the at least one of the one or more marketing routines comprises one or more marketing routines for rewarding the customer. In an exemplary embodiment, the at least one of the one or more marketing routines comprises one or more marketing routines for communicating one or more marketing messages to the customer. In an exemplary embodiment, the at least one of the one or more marketing routines comprises one or more marketing routines for soliciting data from the customer. In an exemplary embodiment, the method comprises permitting the customer to dispense fuel from the fuel dispenser. In an exemplary embodiment, executing one or more marketing routines comprises executing one or more marketing routines before permitting the customer to dispense fuel from the fuel dispenser. In an exemplary embodiment, at least one of the one or more marketing routines executed before permitting the customer to dispense fuel from the fuel dispenser is at least partially dependent upon the at least one characteristic specific to the customer of the fuel dispenser. In an exemplary embodiment, executing one or more marketing routines comprises executing one or more marketing routines after permitting the customer to dispense fuel from the fuel dispenser. In an exemplary embodiment, at least one of the one or more marketing routines executed after permitting the customer to dispense fuel from the fuel dispenser is at least partially dependent upon the at least one characteristic specific to the customer of the fuel dispenser. In an exemplary embodiment, executing one or more marketing routines comprises executing one or more marketing routines before permitting the customer to dispense fuel from the fuel dispenser; and executing one or more marketing routines after permitting the customer to dispense fuel from the fuel dispenser; wherein at least one of the one or more marketing routines executed before permitting the customer to dispense fuel from the fuel dispenser is at least partially dependent upon the at least one characteristic specific to the customer of the fuel dispenser; and wherein at least one of the one or more marketing routines executed before permitting the customer to dispense fuel from the fuel dispenser is at least partially dependent upon the at least one characteristic specific to the customer of the fuel dispenser. In an exemplary embodiment, executing one or more marketing routines comprises at least one of: executing a first marketing routine before permitting the customer to dispense fuel from the fuel dispenser; executing a second marketing routine after permitting the customer to dispense fuel from the fuel dispenser; and executing a third marketing routine after permitting the customer to dispense fuel from the fuel dispenser. In an exemplary embodiment, the at least one characteristic is selected from the group consisting of an area in which the fuel dispenser is located, a payment type used by the customer, a product type desired by the customer, a loyalty identifier used by the customer and data specific to the customer. In an exemplary embodiment, the method comprises transmitting the at least one characteristic to a remote location for storage in a database. In an exemplary embodiment, the payment type is selected from the group consisting of a proprietary credit card payment, a branded credit card payment, a third party credit card payment, a debit card payment, a cash payment and a coupon payment. In an exemplary embodiment, executing the first marketing routine comprises determining the availability of a promotion rule; determining the promotion rule if the promotion rule is available; determining the availability of a first reward to the customer in response to determining the availability of a promotion rule and determining the promotion rule; determining the first reward if the first reward is available; and providing the first reward to the customer if the first reward is available. In an exemplary embodiment, a start date/time and an end date/time are associated with the promotion rule; and wherein determining the availability of the promotion rule comprises determining a current date and time associated with the use of the fuel dispenser by the customer; and determining whether the current date and time falls between the start date/time and the end date/time. In an exemplary embodiment, the at least one characteristic is a location associated with the use of the fuel dispenser; and wherein determining the availability of the promotion rule comprises verifying that the promotion rule applies to the location associated with the use of the fuel dispenser. In an exemplary embodiment, the at least one characteristic is a payment type used by the customer; and wherein determining the availability of the promotion rule comprises verifying that the promotion rule applies to the payment type used by the customer. In an exemplary embodiment, determining the promotion rule comprises looking up a loyalty promotion code in a loyalty promotion table; and determining a group discount associated with the loyalty promotion code. In an exemplary embodiment, the loyalty promotion table is stored in a computer readable medium that is accessible to a processor wherein the processor is in communication with the fuel dispenser; and wherein the loyalty promotion table is downloaded to the computer readable medium from a remote location via a network before determining the promotion rule. In an exemplary embodiment, the loyalty promotion table is downloaded to the computer readable medium at one or more predetermined times; and wherein instructions for storage in the computer readable medium and execution by the processor are downloaded to the computer readable medium from the remote location via the network at one or more predetermined times. In an exemplary embodiment, determining the availability of the promotion rule comprises transmitting the at least one characteristic to a remote location; determining at the remote location a loyalty promotion code in response to the at least one characteristic; and determining whether the loyalty promotion code is in a loyalty promotion table associated with the fuel dispenser; wherein determining the promotion rule comprises determining a group discount associated with the loyalty promotion code if the loyalty promotion code is in the loyalty promotion table associated with the fuel dispenser. In an exemplary embodiment, determining the first reward comprises determining whether a local discount is available; and determining the local discount if the local discount is available. In an exemplary embodiment, determining the first reward further comprises comparing the local discount with the group discount associated with the loyalty promotion code. In an exemplary embodiment, comparing the local discount with the group discount associated with the loyalty promotion code comprises determining a largest immediate discount between the local discount and the group discount; wherein the first reward is in the form of the local discount if the local discount is the largest immediate discount; and wherein the first reward is in the form of the group discount if the local discount is the largest immediate discount. In an exemplary embodiment, comparing the local discount with the group discount associated with the loyalty promotion code comprises determining whether the local discount is associated with a customer-entered point-of-purchase code; and wherein the first reward is in the form of the local discount if the local discount is associated with the customer-entered point-of-purchase code. In an exemplary embodiment, comparing the local discount with the group discount associated with the loyalty promotion code comprises determining whether the local discount is associated with a membership-mode discount; and wherein the first reward is in the form of the local discount if the local discount is associated with the membership-mode discount. In an exemplary embodiment, the first reward is in the form of a coupon. In an exemplary embodiment, the coupon is in the form of a scannable bar code on a printed receipt for payment for the fuel dispensed from the fuel dispenser. In an exemplary embodiment, the first reward is in the form of a discount off of the price of the fuel to be dispensed from the fuel dispenser wherein the discount is selected from the group consisting of a percentage discount, a cent-per-quantity discount and a dollar-value discount. In an exemplary embodiment, the discount is limited to a maximum dollar value. In an exemplary embodiment, the method comprises capturing information associated with the first reward, the information comprising the form of the first reward and the at least one characteristic; and transmitting the information to a remote location for storage in a database. In an exemplary embodiment, executing the first marketing routine further comprises communicating one or more messages to the customer. In an exemplary embodiment, the at least one characteristic is a payment type used by the customer; and wherein at least one message of the one or more messages is in response to the payment type. In an exemplary embodiment, the payment type is in the form of a proprietary credit card payment and wherein the at least one message is in the form of a thank you message to the customer for using the proprietary credit card. In an exemplary embodiment, the at least one message is in the form of a marketing message encouraging the customer to apply for a proprietary credit card. In an exemplary embodiment, the at least one message is in the form of a congratulatory message informing the customer of the provision of the first reward to the customer if the first reward is available. In an exemplary embodiment, the at least one message is in the form of an informational message informing the customer of an available discount off of the price of a potential purchase in the vicinity of the fuel dispenser. In an exemplary embodiment, executing the second marketing routine comprises communicating one or more marketing messages to the customer. In an exemplary embodiment, at least one message of the one or more marketing messages is in response to the at least one characteristic. In an exemplary embodiment, the at least one characteristic is a payment type used by the customer; and wherein at least one message of the one or more marketing messages is in response to the payment type. In an exemplary embodiment, the payment type is in the form of a third party credit card payment; and wherein the at least one message is in the form of an informational marketing message informing the customer of the discount that would have been available to the customer had the payment type been in an alternate form. In an exemplary embodiment, the alternate form is selected from the group consisting of a proprietary credit card payment and a branded credit card payment. In an exemplary embodiment, the at least one message is in the form of an informational marketing message encouraging the customer to apply for a proprietary credit card. In an exemplary embodiment, the payment type is in the form of a proprietary credit card payment; and wherein the at least one message is in the form of a thank you message to the customer for using the proprietary credit card. In an exemplary embodiment, the method comprises approving the customer for a predetermined credit card; wherein the at least one message is in the form of an informational message informing the customer that the customer has been automatically approved for the predetermined credit card. In an exemplary embodiment, the at least one message is in the form of a question asking whether the customer desires to apply for a predetermined credit card. In an exemplary embodiment, at least one other message of the one or more marketing messages is in the form of an informational message informing the customer of at least one incentive in connection with applying for the predetermined credit card. In an exemplary embodiment, the at least one message is in the form of an informational message informing the customer of an available discount off of the price of a potential purchase in the vicinity of the fuel dispenser. In an exemplary embodiment, executing the third marketing routine comprises determining the availability of a second reward; determining the second reward if the second reward is available; and providing the second reward to the customer if the second reward is available. In an exemplary embodiment, the first reward is in the form of a discount off of the price of the fuel dispensed from the fuel dispenser wherein the discount is selected from the group consisting of a percentage discount, a cent-per-quantity discount and a dollar-value discount; and wherein executing the third marketing routine further comprises communicating at least one message to the customer regarding the providing of the first reward if the first reward is available. In an exemplary embodiment, the at least one message to the customer regarding the providing of the first reward is in the form of a congratulatory message that indicates the discount that the customer received. In an exemplary embodiment, the second reward is in the form of a discount off of the price of the fuel dispensed from the fuel dispenser wherein the discount is selected from the group consisting of a percentage discount, a cent-per-quantity discount and a dollar-value discount. In an exemplary embodiment, determining the availability of the second reward comprises determining whether a minimum amount of fuel has been purchased by the customer. In an exemplary embodiment, the second reward is in the form of a discount off of a purchase; and wherein determining the availability of the second reward comprises determining whether the customer made the purchase. In an exemplary embodiment, the method comprises transmitting to a remote location information associated with the second reward, the information comprising the form of the second reward and the at least one characteristic; and storing the information in a database at the remote location. In an exemplary embodiment, executing the third marketing routine further comprises soliciting data from the customer. In an exemplary embodiment, the data is in a form selected from the group consisting of a telephone number, a zip code, the last four digits of the customer's social security number, a name, a mailing address, a driver's license number and an e-mail address. In an exemplary embodiment, soliciting comprises capturing the data from the customer. In an exemplary embodiment, capturing comprises transmitting the data to a remote location. In an exemplary embodiment, the data is in the form of a telephone number and wherein soliciting further comprises calling the telephone number and offering the customer a product or service. In an exemplary embodiment, the method comprises drawing the attention of the customer to the fuel dispenser in order for the customer to respond to at least a portion of the execution of at least one of the first, second or third marketing routines. In an exemplary embodiment, drawing comprises generating at least one audio alert at the fuel dispenser. In an exemplary embodiment, drawing comprises generating an animated graphic at the fuel dispenser.

A method of operating a fuel dispenser has been described that includes identifying at least one characteristic specific to a customer of the fuel dispenser; transmitting the at least one characteristic to a remote location; permitting the customer to dispense fuel from the fuel dispenser; and executing one or more marketing routines; wherein at least one of the one or more marketing routines is at least partially dependent upon the at least one characteristic specific to the customer of the fuel dispenser; and wherein executing one or more marketing routines comprises executing a first marketing routine before permitting the customer to dispense fuel from the fuel dispenser, wherein executing the first marketing routine comprises determining the availability of a promotion rule; determining the promotion rule if the promotion rule is available wherein determining the promotion rule comprises looking up a loyalty promotion code in a loyalty promotion table wherein the loyalty promotion table is downloaded from the remote location; determining the availability of a first reward to the customer in response to determining the availability of a promotion rule and determining the promotion rule; determining the first reward if the first reward is available; and providing the first reward to the customer if the first reward is available; executing a second marketing routine after permitting the customer to dispense fuel from the fuel dispenser, wherein executing the second marketing routine comprises communicating one or more marketing messages to the customer; and executing a third marketing routine after permitting the customer to dispense fuel from the fuel dispenser, wherein executing the third marketing routine comprises communicating at least one message to the customer regarding the providing of the first reward if the first reward is available; determining the availability of a second reward; determining the second reward if the second reward is available; providing the second reward to the customer if the second reward is available; and soliciting data from the customer.

A system has been described that includes a host computer; one or more point-of-sale units in communication with the host computer via a network, each of the one or more point-of-sale units adapted to be operably coupled to one or more fuel dispensers; and a computer readable medium operably coupled to the host computer, the computer readable medium comprising a database stored therein, the database comprising a loyalty promotion table; wherein at least a portion of the operation of the one or more fuel dispensers is adapted to be at least partially dependent upon the loyalty promotion table. In an exemplary embodiment, the loyalty promotion table is adapted to be downloaded to the one or more point-of-sale units via the host computer and the network at one or more predetermined times. In an exemplary embodiment, the platform of at least one of the one or more point-of-sale units is different than the platform of at least one other of the one or more point-of-sale units. In an exemplary embodiment, each of the one or more fuel dispensers comprises a data interface unit in communication with the corresponding point-of-sale unit for receiving data from a customer of one of the one or more fuel dispensers and transmitting the data to the corresponding point-of-sale unit. In an exemplary embodiment, the data is uploadable from the corresponding point-of-sale unit to the database via the network and the host computer. In an exemplary embodiment, each of the one or more point-of-sale units comprises a processor; and a memory accessible to the processor for storing instructions executable by the processor, the instructions comprising instructions for identifying at least one characteristic specific to a customer of the corresponding fuel dispenser; instructions for permitting the customer to dispense fuel from the fuel dispenser; and instructions for executing one or more marketing routines, comprising at least one of: instructions for executing a first marketing routine before executing the permitting instructions; instructions for executing a second marketing routine after executing the permitting instructions; and instructions for executing a third marketing routine after executing the permitting instructions. In an exemplary embodiment, the at least one characteristic is selected from the group consisting of an area in which the fuel dispenser is located, a payment type used by the customer, a product type desired by the customer, a loyalty identifier used by the customer and data specific to the customer. In an exemplary embodiment, the at least one characteristic is transmitted, via the network and the host computer, to the database for storage therein. In an exemplary embodiment, the payment type is selected from the group consisting of a proprietary credit card payment, a branded credit card payment, a third party credit card payment, a debit card payment, a cash payment and a coupon payment. In an exemplary embodiment, the instructions for executing the first marketing routine comprise instructions for determining the availability of a promotion rule; instructions for determining the promotion rule if the promotion rule is available; instructions for determining the availability of a first reward to the customer in response to determining the availability of a promotion rule and determining the promotion rule; instructions for determining the first reward if the first reward is available; and instructions for providing the first reward to the customer if the first reward is available. In an exemplary embodiment, a start date/time and an end date/time are associated with the promotion rule; and wherein the instructions for determining the availability of the promotion rule comprise instructions for determining a current date and time associated with the use of the fuel dispenser by the customer; and instructions for determining whether the current date and time falls between the start date/time and the end date/time. In an exemplary embodiment, the at least one characteristic is a location associated with the use of the fuel dispenser by the customer; and wherein the instructions for determining the availability of the promotion rule comprise verifying that the promotion rule applies to the location associated with the use of the fuel dispenser by the customer. In an exemplary embodiment, the at least one characteristic is a payment type used by the customer; and wherein the instructions for determining the availability of the promotion rule comprise instructions for verifying that the promotion rule applies to the payment type used by the customer. In an exemplary embodiment, the loyalty promotion table is downloaded to the computer readable medium for storage therein via the host computer and the network before executing the instructions for determining the promotion rule; and wherein at least a portion of the instructions executable by the processor is downloaded to the computer readable medium for storage therein via the host computer and the network at one or more predetermined times. In an exemplary embodiment, the instructions for determining the promotion rule comprise instructions for looking up a loyalty promotion code in the loyalty promotion table; and instructions for determining a group discount associated with the loyalty promotion code. In an exemplary embodiment, the instructions for determining the availability of the promotion rule comprise instructions for transmitting the at least one characteristic to the host computer wherein the host computer determines a loyalty promotion code in response to the at least one characteristic and transmits the loyalty promotion code to the corresponding point-of-sale unit; and instructions for determining whether the loyalty promotion code is in the loyalty promotion table. In an exemplary embodiment, the instructions for determining the promotion rule comprise instructions for determining a group discount associated with the loyalty promotion code if the loyalty promotion code is in the loyalty promotion table associated with the fuel dispenser. In an exemplary embodiment, the instructions for determining the first reward comprise instructions for determining whether a local discount is available; and instructions for determining the local discount if the local discount is available. In an exemplary embodiment, the instructions for determining the first reward further comprise instructions for comparing the local discount with the group discount associated with the loyalty promotion code. In an exemplary embodiment, the instructions for comparing the local discount with the group discount associated with the loyalty promotion code comprise instructions for determining a largest immediate discount between the local discount and the group discount; wherein the first reward is in the form of the local discount if the local discount is the largest immediate discount; and wherein the first reward is in the form of the group discount if the local discount is the largest immediate discount. In an exemplary embodiment, the instructions for comparing the local discount with the group discount associated with the loyalty promotion code comprise instructions for determining whether the local discount is associated with a customer-entered point-of-purchase code; and wherein the first reward is in the form of the local discount if the local discount is associated with the customer-entered point-of-purchase code. In an exemplary embodiment, the instructions for comparing the local discount with the group discount associated with the loyalty promotion code comprise instructions for determining whether the local discount is associated with a membership-mode discount; and wherein the first reward is in the form of the local discount if the local discount is associated with the membership-mode discount. In an exemplary embodiment, the first reward is in the form of a coupon. In an exemplary embodiment, the coupon is in the form of a scannable bar code on a printed receipt for payment for the fuel dispensed from the fuel dispenser. In an exemplary embodiment, the first reward is in the form of a discount off of the price of the fuel to be dispensed from the fuel dispenser wherein the discount is selected from the group consisting of a percentage discount, a cent-per-quantity discount and a dollar-value discount. In an exemplary embodiment, the discount is limited to a maximum dollar value. In an exemplary embodiment, the instructions executable by the processor comprise instructions for capturing information associated with the first reward, the information comprising the form of the first reward and the at least one characteristic; and instructions for transmitting the information to a remote location for storage in a database. In an exemplary embodiment, the instructions for executing the first marketing routine comprise instructions for communicating one or more messages to the customer. In an exemplary embodiment, the at least one characteristic is a payment type used by the customer; and wherein at least one message of the one or more messages is in response to the payment type. In an exemplary embodiment, the payment type is in the form of a proprietary credit card payment and wherein the at least one message is in the form of a thank you message to the customer for using the proprietary credit card. In an exemplary embodiment, the at least one message is in the form of a marketing message encouraging the customer to apply for a proprietary credit card. In an exemplary embodiment, the at least one message is in the form of a congratulatory message informing the customer of the provision of the first reward to the customer if the first reward is available. In an exemplary embodiment, the at least one message is in the form of an informational message informing the customer of an available discount off of the price of a potential purchase in the vicinity of the fuel dispenser. In an exemplary embodiment, the instructions for executing the second marketing routine comprise instructions for communicating one or more marketing messages to the customer. In an exemplary embodiment, at least one message of the one or more marketing messages is in response to the at least one characteristic. In an exemplary embodiment, the at least one characteristic is a payment type used by the customer; and wherein at least one message of the one or more marketing messages is in response to the payment type. In an exemplary embodiment, the payment type is in the form of a third party credit card payment; and wherein the at least one message is in the form of an informational marketing message informing the customer of the discount that would have been available to the customer had the payment type been in an alternate form. In an exemplary embodiment, the alternate form is selected from the group consisting of a proprietary credit card payment and a branded credit card payment. In an exemplary embodiment, the at least one message is in the form of an informational marketing message encouraging the customer to apply for a proprietary credit card. In an exemplary embodiment, the payment type is in the form of a proprietary credit card payment; and wherein the at least one message is in the form of a thank you message to the customer for using the proprietary credit card. In an exemplary embodiment, the instructions executable by the processor comprise instructions for approving the customer for a predetermined credit card; and wherein the at least one message is in the form of an informational message informing the customer that the customer has been automatically approved for the predetermined credit card. In an exemplary embodiment, the at least one message is in the form of a question asking whether the customer desires to apply for a predetermined credit card. In an exemplary embodiment, at least one other message of the one or more marketing messages is in the form of an informational message informing the customer of at least one incentive in connection with applying for the predetermined credit card. In an exemplary embodiment, the at least one message is in the form of an informational message informing the customer of an available discount off of the price of a potential purchase in the vicinity of the fuel dispenser. In an exemplary embodiment, the instructions for executing the third marketing routine comprise instructions for determining the availability of a second reward; instructions for determining the second reward if the second reward is available; and instructions for providing the second reward to the customer if the second reward is available. In an exemplary embodiment, the first reward is in the form of a discount off of the price of the fuel dispensed from the fuel dispenser wherein the discount is selected from the group consisting of a percentage discount, a cent-per-quantity discount and a dollar-value discount; and wherein the instructions for executing the third marketing routine further comprises communicating at least one message to the customer regarding the providing of the first reward if the first reward is available. In an exemplary embodiment, the at least one message to the customer regarding the providing of the first reward is in the form of a congratulatory message that indicates the discount that the customer received. In an exemplary embodiment, the second reward is in the form of a discount off of the price of the fuel dispensed from the fuel dispenser wherein the discount is selected from the group consisting of a percentage discount, a cent-per-quantity discount and a dollar-value discount. In an exemplary embodiment, the instructions for determining the availability of the second reward comprise instructions for determining whether a minimum amount of fuel has been purchased by the customer. In an exemplary embodiment, the second reward is in the form of a discount off of a purchase; and wherein the instructions for determining the availability of the second comprise instructions for determining whether the customer made the purchase. In an exemplary embodiment, the instructions executable by the processor further comprise instructions for transmitting to a remote location information associated with the second reward, the information comprising the form of the second reward and the at least one characteristic; and instructions for storing the information in a database at the remote location. In an exemplary embodiment, the instructions for executing the third marketing routine further comprise instructions for soliciting data from the customer. In an exemplary embodiment, the data is in a form selected from the group consisting of a telephone number, a zip code, the last four digits of the customer's social security number, a name, a mailing address, a driver's license number and an e-mail address. In an exemplary embodiment, the instructions for soliciting comprise instructions for capturing the data from the customer. In an exemplary embodiment, the instructions for capturing comprise instructions for transmitting the data to a remote location. In an exemplary embodiment, the data is in the form of a telephone number and wherein soliciting further comprises calling the telephone number and offering the customer a product or service. In an exemplary embodiment, the instructions executable by the processor further comprise instructions for drawing the attention of the customer to the fuel dispenser in order for the customer to respond to at least a portion of the execution of at least one of the first, second or third marketing routines. In an exemplary embodiment, the instructions for drawing comprise instructions for generating at least one audio alert at the fuel dispenser. In an exemplary embodiment, the instructions for drawing comprise instructions for generating an animated graphic at the fuel dispenser.

A system has been described that includes a host computer; one or more point-of-sale units in communication with the host computer via a network, each of the one or more point-of-sale units adapted to be operably coupled to one or more fuel dispensers; and a computer readable medium operably coupled to the host computer, the computer readable medium comprising a database stored therein, the database comprising a loyalty promotion table adapted to be downloaded to the one or more point-of-sale units via the host computer and the network; wherein each of the one or more point-of-sale units comprises a processor; and a memory accessible to the processor for storing the loyalty promotion table and for storing instructions executable by the processor, the instructions comprising instructions for identifying at least one characteristic specific to a customer of the corresponding fuel dispenser; instructions for permitting the customer to dispense fuel from the fuel dispenser; and instructions for executing one or more marketing routines, comprising instructions for executing a first marketing routine before executing the permitting instructions, wherein the instructions for executing the first marketing routine comprise instructions for determining the availability of a promotion rule; determining the promotion rule if the promotion rule is available; determining the availability of a first reward to the customer in response to determining the availability of a promotion rule and determining the promotion rule; determining the first reward if the first reward is available; and providing the first reward to the customer if the first reward is available; instructions for executing a second marketing routine after executing the permitting instructions wherein the instructions for executing the second marketing routine comprise instructions for communicating one or more marketing messages to the customer; and instructions for executing a third marketing routine after executing the permitting instructions, wherein the instructions for executing the third marketing routine comprise instructions for determining the availability of a second reward; determining the second reward if the second reward is available; providing the second reward to the customer if the second reward is available; and soliciting data from the customer.

A computer readable medium has been described that includes a plurality of instructions stored therein for operating a fuel dispenser, the instructions comprising instructions for identifying at least one characteristic specific to a customer of the fuel dispenser; and instructions for executing one or more marketing routines; wherein at least one of the one or more marketing routines is at least partially dependent upon the at least one characteristic specific to the customer of the fuel dispenser. In an exemplary embodiment, the at least one of the one or more marketing routines comprises one or more marketing routines for rewarding the customer. In an exemplary embodiment, the at least one of the one or more marketing routines comprises one or more marketing routines for communicating one or more marketing messages to the customer. In an exemplary embodiment, the at least one of the one or more marketing routines comprises one or more marketing routines for soliciting data from the customer. In an exemplary embodiment, the computer readable medium comprises instructions for permitting the customer to dispense fuel from the fuel dispenser. In an exemplary embodiment, the instructions for executing one or more marketing routines comprise instructions for executing one or more marketing routines before permitting the customer to dispense fuel from the fuel dispenser. In an exemplary embodiment, at least one of the one or more marketing routines executed before permitting the customer to dispense fuel from the fuel dispenser is at least partially dependent upon the at least one characteristic specific to the customer of the fuel dispenser. In an exemplary embodiment, the instructions for executing one or more marketing routines comprise instructions for executing one or more marketing routines after permitting the customer to dispense fuel from the fuel dispenser. In an exemplary embodiment, at least one of the one or more marketing routines executed after permitting the customer to dispense fuel from the fuel dispenser is at least partially dependent upon the at least one characteristic specific to the customer of the fuel dispenser. In an exemplary embodiment, the instructions for executing one or more marketing routines comprise instructions for executing one or more marketing routines before permitting the customer to dispense fuel from the fuel dispenser; and instructions for executing one or more marketing routines after permitting the customer to dispense fuel from the fuel dispenser; wherein at least one of the one or more marketing routines executed before permitting the customer to dispense fuel from the fuel dispenser is at least partially dependent upon the at least one characteristic specific to the customer of the fuel dispenser; and wherein at least one of the one or more marketing routines executed before permitting the customer to dispense fuel from the fuel dispenser is at least partially dependent upon the at least one characteristic specific to the customer of the fuel dispenser. In an exemplary embodiment, the instructions for executing one or more marketing routines comprise at least one of: instructions for executing a first marketing routine before executing the permitting instructions; instructions for executing a second marketing routine after executing the permitting instructions; and instructions for executing a third marketing routine after executing the permitting instructions. In an exemplary embodiment, the at least one characteristic is selected from the group consisting of an area in which the fuel dispenser is located, a payment type used by the customer, a product type desired by the customer, a loyalty identifier used by the customer and data specific to the customer. In an exemplary embodiment, the at least one characteristic is transmitted, via the network and the host computer, to the database for storage therein. In an exemplary embodiment, the payment type is selected from the group consisting of a proprietary credit card payment, a branded credit card payment, a third party credit card payment, a debit card payment, a cash payment and a coupon payment. In an exemplary embodiment, the instructions for executing the first marketing routine comprise instructions for determining the availability of a promotion rule; instructions for determining the promotion rule if the promotion rule is available; instructions for determining the availability of a first reward to the customer in response to determining the availability of a promotion rule and determining the promotion rule; instructions for determining the first reward if the first reward is available; and instructions for providing the first reward to the customer if the first reward is available. In an exemplary embodiment, a start date/time and an end date/time are associated with the promotion rule; and wherein the instructions for determining the availability of the promotion rule comprise instructions for determining a current date and time associated with the use of the fuel dispenser by the customer; and instructions for determining whether the current date and time falls between the start date/time and the end date date/time. In an exemplary embodiment, the at least one characteristic is a location associated with the use of the fuel dispenser by the customer; and wherein the instructions for determining the availability of the promotion rule comprise verifying that the promotion rule applies to the location associated with the use of the fuel dispenser by the customer. In an exemplary embodiment, the at least one characteristic is a payment type used by the customer; and wherein the instructions for determining the availability of the promotion rule comprise instructions for verifying that the promotion rule applies to the payment type used by the customer. In an exemplary embodiment, the instructions for determining the promotion rule comprise instructions for looking up a loyalty promotion code in a loyalty promotion table; and instructions for determining a group discount associated with the loyalty promotion code. In an exemplary embodiment, the loyalty promotion table is stored in the computer readable medium; wherein the computer readable medium is accessible to a processor for executing the plurality of instructions for operating the fuel dispenser wherein the processor is in communication with the fuel dispenser; and wherein the loyalty promotion table is downloaded to the computer readable medium from a remote location via a network before determining the promotion rule. In an exemplary embodiment, the loyalty promotion table is downloaded to the computer readable medium at one or more predetermined times; and wherein at least a portion of the plurality of instructions for operating the fuel dispenser is downloaded to the computer readable medium from the remote location via the network at one or more predetermined times. In an exemplary embodiment, the instructions for determining the availability of the promotion rule comprise instructions for transmitting the at least one characteristic to a remote location; instructions for determining at the remote location a loyalty promotion code in response to the at least one characteristic; and instructions for determining whether the loyalty promotion code is in a loyalty promotion table associated with the fuel dispenser; and wherein the instructions for determining the promotion rule comprise instructions for determining a group discount associated with the loyalty promotion code if the loyalty promotion code is in the loyalty promotion table associated with the fuel dispenser. In an exemplary embodiment, the instructions for determining the first reward comprise instructions for determining whether a local discount is available; and instructions for determining the local discount if the local discount is available. In an exemplary embodiment, the instructions for determining the first reward further comprise instructions for comparing the local discount with the group discount associated with the loyalty promotion code. In an exemplary embodiment, the instructions for comparing the local discount with the group discount associated with the loyalty promotion code comprise instructions for determining a largest immediate discount between the local discount and the group discount; wherein the first reward is in the form of the local discount if the local discount is the largest immediate discount; and wherein the first reward is in the form of the group discount if the local discount is the largest immediate discount. In an exemplary embodiment, the instructions for comparing the local discount with the group discount associated with the loyalty promotion code comprise instructions for determining whether the local discount is associated with a customer-entered point-of-purchase code; and wherein the first reward is in the form of the local discount if the local discount is associated with the customer-entered point-of-purchase code. In an exemplary embodiment, the instructions for comparing the local discount with the group discount associated with the loyalty promotion code comprise instructions for determining whether the local discount is associated with a membership-mode discount; and wherein the first reward is in the form of the local discount if the local discount is associated with the membership-mode discount. In an exemplary embodiment, the first reward is in the form of a coupon. In an exemplary embodiment, the coupon is in the form of a scannable bar code on a printed receipt for payment for the fuel dispensed from the fuel dispenser. In an exemplary embodiment, the first reward is in the form of a discount off of the price of the fuel to be dispensed from the fuel dispenser wherein the discount is selected from the group consisting of a percentage discount, a cent-per-quantity discount and a dollar-value discount. In an exemplary embodiment, the discount is limited to a maximum dollar value. In an exemplary embodiment, the instructions executable by the processor further comprise instructions for capturing information associated with the first reward, the information comprising the form of the first reward and the at least one characteristic; and instructions for transmitting the information to a remote location for storage in a database. In an exemplary embodiment, the instructions for executing the first marketing routine further comprise instructions for communicating one or more messages to the customer. In an exemplary embodiment, the at least one characteristic is a payment type used by the customer; and wherein at least one message of the one or more messages is in response to the payment type. In an exemplary embodiment, the payment type is in the form of a proprietary credit card payment and wherein the at least one message is in the form of a thank you message to the customer for using the proprietary credit card. In an exemplary embodiment, the at least one message is in the form of a marketing message encouraging the customer to apply for a proprietary credit card. In an exemplary embodiment, the at least one message is in the form of a congratulatory message informing the customer of the provision of the first reward to the customer if the first reward is available. In an exemplary embodiment, the at least one message is in the form of an informational message informing the customer of an available discount off of the price of a potential purchase in the vicinity of the fuel dispenser. In an exemplary embodiment, the instructions for executing the second marketing routine comprise instructions for communicating one or more marketing messages to the customer. In an exemplary embodiment, at least one message of the one or more marketing messages is in response to the at least one characteristic. In an exemplary embodiment, the at least one characteristic is a payment type used by the customer; and wherein at least one message of the one or more marketing messages is in response to the payment type. In an exemplary embodiment, the payment type is in the form of a third party credit card payment; and wherein the at least one message is in the form of an informational marketing message informing the customer of the discount that would have been available to the customer had the payment type been in an alternate form. In an exemplary embodiment, the alternate form is selected from the group consisting of a proprietary credit card payment and a branded credit card payment. In an exemplary embodiment, the at least one message is in the form of an informational marketing message encouraging the customer to apply for a proprietary credit card. In an exemplary embodiment, the payment type is in the form of a proprietary credit card payment; and wherein the at least one message is in the form of a thank you message to the customer for using the proprietary credit card. In an exemplary embodiment, the computer readable medium comprise instructions for approving the customer for a predetermined credit card; wherein the at least one message is in the form of an informational message informing the customer that the customer has been automatically approved for the predetermined credit card. In an exemplary embodiment, the at least one message is in the form of a question asking whether the customer desires to apply for a predetermined credit card. In an exemplary embodiment, at least one other message of the one or more marketing messages is in the form of an informational message informing the customer of at least one incentive in connection with applying for the predetermined credit card. In an exemplary embodiment, the at least one message is in the form of an informational message informing the customer of an available discount off of the price of a potential purchase in the vicinity of the fuel dispenser. In an exemplary embodiment, the instructions for executing the third marketing routine comprise instructions for determining the availability of a second reward; instructions for determining the second reward if the second reward is available; and instructions for providing the second reward to the customer if the second reward is available. In an exemplary embodiment, the first reward is in the form of a discount off of the price of the fuel dispensed from the fuel dispenser wherein the discount is selected from the group consisting of a percentage discount, a cent-per-quantity discount and a dollar-value discount; and wherein the instructions for executing the third marketing routine further comprise communicating at least one message to the customer regarding the providing of the first reward if the first reward is available. In an exemplary embodiment, the at least one message to the customer regarding the providing of the first reward is in the form of a congratulatory message that indicates the discount that the customer received. In an exemplary embodiment, the second reward is in the form of a discount off of the price of the fuel dispensed from the fuel dispenser wherein the discount is selected from the group consisting of a percentage discount, a cent-per-quantity discount and a dollar-value discount. In an exemplary embodiment, the instructions for determining the availability of the second reward comprise instructions for determining whether a minimum amount of fuel has been purchased by the customer. In an exemplary embodiment, the second reward is in the form of a discount off of a purchase; and wherein the instructions for determining the availability of the second reward comprise instructions for determining whether the customer made the purchase. In an exemplary embodiment, the instructions executable by the processor further comprise instructions for transmitting to a remote location information associated with the second reward, the information comprising the form of the second reward and the at least one characteristic; and instructions for storing the information in a database at the remote location. In an exemplary embodiment, the instructions for executing the third marketing routine further comprise instructions for soliciting data from the customer. In an exemplary embodiment, the data is in a form selected from the group consisting of a telephone number, a zip code, the last four digits of the customer's social security number, a name, a mailing address, a driver's license number and an e-mail address. In an exemplary embodiment, the instructions for soliciting comprise instructions for capturing the data from the customer. In an exemplary embodiment, the instructions for capturing comprise instructions for transmitting the data to a remote location. In an exemplary embodiment, the data is in the form of a telephone number and wherein soliciting further comprises calling the telephone number and offering the customer a product or service. In an exemplary embodiment, the instructions executable by the processor further comprise instructions for drawing the attention of the customer to the fuel dispenser in order for the customer to respond to at least a portion of the execution of at least one of the first, second or third marketing routines. In an exemplary embodiment, the instructions for drawing comprise instructions for generating at least one audio alert at the fuel dispenser. In an exemplary embodiment, the instructions for drawing comprise instructions for generating an animated graphic at the fuel dispenser.

A computer readable medium has been described that includes a plurality of instructions stored therein for operating a fuel dispenser, the instructions comprising instructions for identifying at least one characteristic specific to a customer of the fuel dispenser; instructions for permitting the customer to dispense fuel from the fuel dispenser; instructions for executing one or more marketing routines; wherein at least one of the one or more marketing routines is at least partially dependent upon the at least one characteristic specific to the customer of the fuel dispenser; and wherein the instructions for executing one or more marketing routines comprise instructions for executing a first marketing routine before executing the permitting instructions, wherein the instructions for executing the first marketing routine comprise instructions for determining the availability of a promotion rule; instructions for determining the promotion rule if the promotion rule is available wherein the instructions for determining the promotion rule comprise instructions for looking up a loyalty promotion code in a loyalty promotion table; and instructions for determining a group discount associated with the loyalty promotion code; instructions for determining the availability of a first reward to the customer in response to determining the availability of a promotion rule and determining the promotion rule; instructions for determining the first reward if the first reward is available; and instructions for providing the first reward to the customer if the first reward is available; instructions for executing a second marketing routine after executing the permitting instructions, wherein the instructions for executing the second marketing routine comprise instructions for communicating one or more marketing messages to the customer; and instructions for executing a third marketing routine after executing the permitting instructions, wherein the instructions for executing the third marketing routine comprise instructions for determining the availability of a second reward; instructions for determining the second reward if the second reward is available; and instructions for providing the second reward to the customer if the second reward is available.

A database stored in a computer readable medium and accessible to a device in communication with a fuel dispenser, has been described that includes a loyalty promotion table comprising one or more records, each record comprising a discount-type field for identifying a type of reward to apply to a customer of the fuel dispenser; and at least one reward-criteria field for determining whether the reward is available to the customer of the fuel dispenser. In an exemplary embodiment, the at least one reward-criteria field is selected from the group consisting of a date/time field for defining the active time period during which the reward is available to the customer of the fuel dispenser; a where-applies field for specifying a location to which the reward applies; a payment-type field for restricting the reward to one or more payment types; a required-purchase-department-code field for indicating a product or service that the customer must purchase; and a required-minimum-purchase-type field for specifying a minimum quantity of a product that the customer must purchase. In an exemplary embodiment, each record further comprises at least one other criteria field for determining whether the reward is available to the customer of the fuel dispenser. In an exemplary embodiment, the at least one other criteria field is selected from the group consisting of a date/time field for defining the active time period during which the reward is available to the customer of the fuel dispenser; a where-applies field for specifying a location to which the reward applies; a payment-type field for restricting the reward to one or more payment types; a required-purchase-department-code field for indicating a product or service that the customer must purchase; and a required-minimum-purchase-type field for specifying a minimum quantity of a product that the customer must purchase. In an exemplary embodiment, each record further comprises at least one message-text field containing one or more marketing messages to be communicated to the customer of the fuel dispenser. In an exemplary embodiment, each record further comprises at least one message-slot field for indicating a time period during which at least one of the marketing messages are to be communicated. In an exemplary embodiment, the time period is selected from the group consisting of a time period before the customer is permitted to dispense fuel from the fuel dispenser; and a time period after the customer is permitted to dispense fuel from the fuel dispenser. In an exemplary embodiment, each record further comprises a promotion-code field for identifying the corresponding record. In an exemplary embodiment, each record further comprises an attention-drawing field for drawing the attention of the customer of the fuel dispenser to the fuel dispenser. In an exemplary embodiment, the attention-drawing field is selected from the group consisting of an animated-graphic field and an audio-alert field. In an exemplary embodiment, each record further comprises a solicit-prompt field for prompting the customer to provide one type of data. In an exemplary embodiment, each record further comprises a discount-amount field for indicating the value of the reward to apply. In an exemplary embodiment, each record further comprises a maximum-discount-amount field for specifying the maximum possible value of the reward. In an exemplary embodiment, the device is a host computer. In an exemplary embodiment, the host computer is remotely located from the fuel dispenser. In an exemplary embodiment, wherein the device is a processor and wherein the processor and the computer readable medium are components of a point-of-sale unit. In an exemplary embodiment, the device is a host computer and wherein the loyalty promotion table is adapted to be downloaded via a network to a point-of-sale unit for storage therein at one or more predetermined times; and wherein the point-of-sale unit is in communication with the fuel dispenser. In an exemplary embodiment, the point-of-sale unit comprises a processor and a memory accessible thereto; and wherein the loyalty promotion table is stored in the memory after the loyalty promotion table is downloaded. In an exemplary embodiment, for operating the fuel dispenser, the processor accesses the loyalty promotion table and executes instructions stored in the memory. In an exemplary embodiment, at least a portion of the instructions stored in the memory are downloaded from the host computer to the point-of-sale unit via the network at one or more predetermined times. In an exemplary embodiment, the instructions stored in the memory comprise instructions for identifying at least one characteristic specific to a customer of the fuel dispenser; instructions for permitting the customer to dispense fuel from the fuel dispenser; and instructions for executing one or more marketing routines, comprising at least one of: instructions for executing a first marketing routine before executing the permitting instructions; instructions for executing a second marketing routine after executing the permitting instructions; and instructions for executing a third marketing routine after executing the permitting instructions. In an exemplary embodiment, the at least one characteristic is selected from the group consisting of an area in which the fuel dispenser is located, a payment type used by the customer, a product type desired by the customer, a loyalty identifier used by the customer and data specific to the customer. In an exemplary embodiment, the at least one characteristic is transmitted to the database for storage therein. In an exemplary embodiment, the payment type is selected from the group consisting of a proprietary credit card payment, a branded credit card payment, a third party credit card payment, a debit card payment, a cash payment and a coupon payment. In an exemplary embodiment, the instructions for executing the first marketing routine comprise instructions for determining the availability of a promotion rule; instructions for determining the promotion rule if the promotion rule is available; instructions for determining the availability of a first reward to the customer in response to determining the availability of a promotion rule and determining the promotion rule; instructions for determining the first reward if the first reward is available; and instructions for providing the first reward to the customer if the first reward is available. In an exemplary embodiment, the instructions stored in the memory further comprise instructions for capturing information associated with the first reward, the information comprising the form of the first reward and the at least one characteristic; and instructions for transmitting the information to the database for storage therein. In an exemplary embodiment, the instructions for executing the first marketing routine further comprise instructions for communicating one or more messages to the customer. In an exemplary embodiment, the instructions for executing the second marketing routine comprise instructions for communicating one or more marketing messages to the customer. In an exemplary embodiment, the instructions for executing the third marketing routine comprise instructions for determining the availability of a second reward; instructions for determining the second reward if the second reward is available; and instructions for providing the second reward to the customer if the second reward is available. In an exemplary embodiment, the instructions for executing the third marketing routine further comprise instructions for soliciting data from the customer. In an exemplary embodiment, the instructions for soliciting comprise instructions for capturing the data from the customer.

A database stored in a computer readable medium and accessible to a processor in communication with a fuel dispenser, has been described that includes a loyalty promotion table comprising one or more records, each record comprising a discount-type field for identifying a type of reward to apply to a customer of the fuel dispenser; at least one reward-criteria field for determining whether the reward is available to the customer of the fuel dispenser; at least one message-slot field for indicating a time period during which at least one of the marketing messages are to be communicated; at least one message-slot field for indicating a time period during which at least one of the marketing messages are to be communicated wherein the time period is selected from the group consisting of a time period before the customer is permitted to dispense fuel from the fuel dispenser; and a time period after the customer is permitted to dispense fuel from the fuel dispenser; a solicit-prompt field for prompting the customer to provide one type of data; and a discount-amount field for indicating the value of the reward to apply; wherein the processor and the computer readable medium are components of a point-of-sale unit and the loyalty promotion table is adapted to be downloaded via a network to the computer readable medium for storage therein at one or more predetermined times; wherein, for operating the fuel dispenser, the processor accesses the loyalty promotion table and executes instructions stored in the computer readable medium; and wherein the at least one reward-criteria field is selected from the group consisting of a date/time field for defining the active time period during which the reward is available to the customer of the fuel dispenser; a where-applies field for specifying a location to which the reward applies; a payment-type field for restricting the reward to one or more payment types; a required-purchase-department-code field for indicating a product or service that the customer must purchase; and a required-minimum-purchase-type field for specifying a minimum quantity of a product that the customer must purchase.

A system for operating a fuel dispenser has been described that includes means for identifying at least one characteristic specific to a customer of the fuel dispenser; and means for executing one or more marketing routines; wherein at least one of the one or more marketing routines is at least partially dependent upon the at least one characteristic specific to the customer of the fuel dispenser. In an exemplary embodiment, the at least one of the one or more marketing routines comprises one or more marketing routines for rewarding the customer. In an exemplary embodiment, the at least one of the one or more marketing routines comprises one or more marketing routines for communicating one or more marketing messages to the customer. In an exemplary embodiment, the at least one of the one or more marketing routines comprises one or more marketing routines for soliciting data from the customer. In an exemplary embodiment, the system comprises means for permitting the customer to dispense fuel from the fuel dispenser. In an exemplary embodiment, means for executing one or more marketing routines comprises means for executing one or more marketing routines before permitting the customer to dispense fuel from the fuel dispenser. In an exemplary embodiment, at least one of the one or more marketing routines executed before permitting the customer to dispense fuel from the fuel dispenser is at least partially dependent upon the at least one characteristic specific to the customer of the fuel dispenser. In an exemplary embodiment, means for executing one or more marketing routines comprises means for executing one or more marketing routines after permitting the customer to dispense fuel from the fuel dispenser. In an exemplary embodiment, at least one of the one or more marketing routines executed after permitting the customer to dispense fuel from the fuel dispenser is at least partially dependent upon the at least one characteristic specific to the customer of the fuel dispenser. In an exemplary embodiment, means for executing one or more marketing routines comprises means for executing one or more marketing routines before permitting the customer to dispense fuel from the fuel dispenser; and means for executing one or more marketing routines after permitting the customer to dispense fuel from the fuel dispenser; wherein at least one of the one or more marketing routines executed before permitting the customer to dispense fuel from the fuel dispenser is at least partially dependent upon the at least one characteristic specific to the customer of the fuel dispenser; and wherein at least one of the one or more marketing routines executed before permitting the customer to dispense fuel from the fuel dispenser is at least partially dependent upon the at least one characteristic specific to the customer of the fuel dispenser. In an exemplary embodiment, means for executing one or more marketing routines comprises at least one of: means for executing a first marketing routine before permitting the customer to dispense fuel from the fuel dispenser; means for executing a second marketing routine after permitting the customer to dispense fuel from the fuel dispenser; and means for executing a third marketing routine after permitting the customer to dispense fuel from the fuel dispenser. In an exemplary embodiment, the at least one characteristic is selected from the group consisting of an area in which the fuel dispenser is located, a payment type used by the customer, a product type desired by the customer, a loyalty identifier used by the customer and data specific to the customer. In an exemplary embodiment, the system comprises means for transmitting the at least one characteristic to a remote location for storage in a database. In an exemplary embodiment, the payment type is selected from the group consisting of a proprietary credit card payment, a branded credit card payment, a third party credit card payment, a debit card payment, a cash payment and a coupon payment. In an exemplary embodiment, means for executing the first marketing routine comprises means for determining the availability of a promotion rule; means for determining the promotion rule if the promotion rule is available; means for determining the availability of a first reward to the customer in response to determining the availability of a promotion rule and determining the promotion rule; means for determining the first reward if the first reward is available; and means for providing the first reward to the customer if the first reward is available. In an exemplary embodiment, a start date/time and an end date/time are associated with the promotion rule; and wherein means for determining the availability of the promotion rule comprises means for determining a current date and time associated with the use of the fuel dispenser by the customer; and means for determining whether the current date and time falls between the start date/time and the end date/time. In an exemplary embodiment, the at least one characteristic is a location associated with the use of the fuel dispenser; and wherein means for determining the availability of the promotion rule comprises means for verifying that the promotion rule applies to the location associated with the use of the fuel dispenser. In an exemplary embodiment, the at least one characteristic is a payment type used by the customer; and wherein means for determining the availability of the promotion rule comprises means for verifying that the promotion rule applies to the payment type used by the customer. In an exemplary embodiment, means for determining the promotion rule comprises means for looking up a loyalty promotion code in a loyalty promotion table; and means for determining a group discount associated with the loyalty promotion code. In an exemplary embodiment, the loyalty promotion table is stored in a computer readable medium that is accessible to a processor wherein the processor is in communication with the fuel dispenser; and wherein the loyalty promotion table is downloaded to the computer readable medium from a remote location via a network before determining the promotion rule. In an exemplary embodiment, the loyalty promotion table is downloaded to the computer readable medium at one or more predetermined times; and wherein instructions for storage in the computer readable medium and execution by the processor are downloaded to the computer readable medium from the remote location via the network at one or more predetermined times. In an exemplary embodiment, means for determining the availability of the promotion rule comprises means for transmitting the at least one characteristic to a remote location; means for determining at the remote location a loyalty promotion code in response to the at least one characteristic; and means for determining whether the loyalty promotion code is in a loyalty promotion table associated with the fuel dispenser; wherein means for determining the promotion rule comprises means for determining a group discount associated with the loyalty promotion code if the loyalty promotion code is in the loyalty promotion table associated with the fuel dispenser. In an exemplary embodiment, means for determining the first reward comprises means for determining whether a local discount is available; and means for determining the local discount if the local discount is available. In an exemplary embodiment, means for determining the first reward further comprises means for comparing the local discount with the group discount associated with the loyalty promotion code. In an exemplary embodiment, means for comparing the local discount with the group discount associated with the loyalty promotion code comprises means for determining a largest immediate discount between the local discount and the group discount; wherein the first reward is in the form of the local discount if the local discount is the largest immediate discount; and wherein the first reward is in the form of the group discount if the local discount is the largest immediate discount. In an exemplary embodiment, means for comparing the local discount with the group discount associated with the loyalty promotion code comprises means for determining whether the local discount is associated with a customer-entered point-of-purchase code; and wherein the first reward is in the form of the local discount if the local discount is associated with the customer-entered point-of-purchase code. In an exemplary embodiment, means for comparing the local discount with the group discount associated with the loyalty promotion code comprises means for determining whether the local discount is associated with a membership-mode discount; and wherein the first reward is in the form of the local discount if the local discount is associated with the membership-mode discount. In an exemplary embodiment, the first reward is in the form of a coupon. In an exemplary embodiment, the coupon is in the form of a scannable bar code on a printed receipt for payment for the fuel dispensed from the fuel dispenser. In an exemplary embodiment, the first reward is in the form of a discount off of the price of the fuel to be dispensed from the fuel dispenser wherein the discount is selected from the group consisting of a percentage discount, a cent-per-quantity discount and a dollar-value discount. In an exemplary embodiment, the discount is limited to a maximum dollar value. In an exemplary embodiment, the system comprises means for capturing information associated with the first reward, the information comprising the form of the first reward and the at least one characteristic; and means for transmitting the information to a remote location for storage in a database. In an exemplary embodiment, means for executing the first marketing routine further comprises means for communicating one or more messages to the customer. In an exemplary embodiment, the at least one characteristic is a payment type used by the customer; and wherein at least one message of the one or more messages is in response to the payment type. In an exemplary embodiment, the payment type is in the form of a proprietary credit card payment and wherein the at least one message is in the form of a thank you message to the customer for using the proprietary credit card. In an exemplary embodiment, the at least one message is in the form of a marketing message encouraging the customer to apply for a proprietary credit card. In an exemplary embodiment, the at least one message is in the form of a congratulatory message informing the customer of the provision of the first reward to the customer if the first reward is available. In an exemplary embodiment, the at least one message is in the form of an informational message informing the customer of an available discount off of the price of a potential purchase in the vicinity of the fuel dispenser. In an exemplary embodiment, means for executing the second marketing routine comprises means for communicating one or more marketing messages to the customer. In an exemplary embodiment, at least one message of the one or more marketing messages is in response to the at least one characteristic. In an exemplary embodiment, the at least one characteristic is a payment type used by the customer; and wherein at least one message of the one or more marketing messages is in response to the payment type. In an exemplary embodiment, the payment type is in the form of a third party credit card payment; and wherein the at least one message is in the form of an informational marketing message informing the customer of the discount that would have been available to the customer had the payment type been in an alternate form. In an exemplary embodiment, the alternate form is selected from the group consisting of a proprietary credit card payment and a branded credit card payment. In an exemplary embodiment, the at least one message is in the form of an informational marketing message encouraging the customer to apply for a proprietary credit card. In an exemplary embodiment, the payment type is in the form of a proprietary credit card payment; and wherein the at least one message is in the form of a thank you message to the customer for using the proprietary credit card. In an exemplary embodiment, the system comprises means for approving the customer for a predetermined credit card; wherein the at least one message is in the form of an informational message informing the customer that the customer has been automatically approved for the predetermined credit card. In an exemplary embodiment, the at least one message is in the form of a question asking whether the customer desires to apply for a predetermined credit card. In an exemplary embodiment, at least one other message of the one or more marketing messages is in the form of an informational message informing the customer of at least one incentive in connection with applying for the predetermined credit card. In an exemplary embodiment, the at least one message is in the form of an informational message informing the customer of an available discount off of the price of a potential purchase in the vicinity of the fuel dispenser. In an exemplary embodiment, means for executing the third marketing routine comprises means for determining the availability of a second reward; means for determining the second reward if the second reward is available; and means for providing the second reward to the customer if the second reward is available. In an exemplary embodiment, the first reward is in the form of a discount off of the price of the fuel dispensed from the fuel dispenser wherein the discount is selected from the group consisting of a percentage discount, a cent-per-quantity discount and a dollar-value discount; and wherein means for executing the third marketing routine further comprises means for communicating at least one message to the customer regarding the providing of the first reward if the first reward is available. In an exemplary embodiment, the at least one message to the customer regarding the providing of the first reward is in the form of a congratulatory message that indicates the discount that the customer received. In an exemplary embodiment, the second reward is in the form of a discount off of the price of the fuel dispensed from the fuel dispenser wherein the discount is selected from the group consisting of a percentage discount, a cent-per-quantity discount and a dollar-value discount. In an exemplary embodiment, means for determining the availability of the second reward comprises means for determining whether a minimum amount of fuel has been purchased by the customer. In an exemplary embodiment, the second reward is in the form of a discount off of a purchase; and wherein means for determining the availability of the second reward comprises means for determining whether the customer made the purchase. In an exemplary embodiment, the system comprises means for transmitting to a remote location information associated with the second reward, the information comprising the form of the second reward and the at least one characteristic; and means for storing the information in a database at the remote location. In an exemplary embodiment, means for executing the third marketing routine further comprises means for soliciting data from the customer. In an exemplary embodiment, the data is in a form selected from the group consisting of a telephone number, a zip code, the last four digits of the customer's social security number, a name, a mailing address, a driver's license number and an e-mail address. In an exemplary embodiment, means for soliciting comprises means for capturing the data from the customer. In an exemplary embodiment, means for capturing comprises means for transmitting the data to a remote location. In an exemplary embodiment, the data is in the form of a telephone number and wherein means for soliciting further comprises means for calling the telephone number and offering the customer a product or service. In an exemplary embodiment, the system comprises means for drawing the attention of the customer to the fuel dispenser in order for the customer to respond to at least a portion of the execution of at least one of the first, second or third marketing routines. In an exemplary embodiment, means for drawing comprises means for generating at least one audio alert at the fuel dispenser. In an exemplary embodiment, means for drawing comprises means for generating an animated graphic at the fuel dispenser.

A system for operating a fuel dispenser has been described that includes means for identifying at least one characteristic specific to a customer of the fuel dispenser; means for transmitting the at least one characteristic to a remote location; means for permitting the customer to dispense fuel from the fuel dispenser; and means for executing one or more marketing routines; wherein at least one of the one or more marketing routines is at least partially dependent upon the at least one characteristic specific to the customer of the fuel dispenser; and wherein means for executing one or more marketing routines comprises means for executing a first marketing routine before permitting the customer to dispense fuel from the fuel dispenser, wherein means for executing the first marketing routine comprises means for determining the availability of a promotion rule; means for determining the promotion rule if the promotion rule is available wherein means for determining the promotion rule comprises means for looking up a loyalty promotion code in a loyalty promotion table wherein the loyalty promotion table is downloaded from the remote location; means for determining the availability of a first reward to the customer in response to determining the availability of a promotion rule and determining the promotion rule; means for determining the first reward if the first reward is available; and means for providing the first reward to the customer if the first reward is available; means for executing a second marketing routine after permitting the customer to dispense fuel from the fuel dispenser, wherein means for executing the second marketing routine comprises means for communicating one or more marketing messages to the customer; and means for executing a third marketing routine after permitting the customer to dispense fuel from the fuel dispenser, wherein means for executing the third marketing routine comprises means for communicating at least one message to the customer regarding the providing of the first reward if the first reward is available; means for determining the availability of a second reward; means for determining the second reward if the second reward is available; means for providing the second reward to the customer if the second reward is available; and means for soliciting data from the customer.

A method has been described that includes identifying at least one characteristic specific to a customer of a device operably coupled to a point-of-sale unit; and executing one or more marketing routines using the point-of-sale unit; wherein at least one of the one or more marketing routines is at least partially dependent upon the at least one characteristic specific to the customer. In an exemplary embodiment, the device comprises a fuel dispenser. In an exemplary embodiment, the device is selected from the group consisting of a keyboard, a card reader, a pin pad, a computer, a scanner, a fuel dispenser and a kiosk. In an exemplary embodiment, the at least one characteristic is selected from the group consisting of an area in which the device is located, a payment type used by the customer, a product type desired by the customer, a loyalty identifier used by the customer and data specific to the customer. In an exemplary embodiment, the point-of-sale unit is in communication with a host computer via a network; and wherein a computer readable medium is operably coupled to the host computer, the computer readable medium comprising a loyalty promotion table stored therein. In an exemplary embodiment, the method comprises downloading the loyalty promotion table to the point-of-sale unit via the host computer and the network at one or more predetermined times. In an exemplary embodiment, executing one or more marketing routines using the point-of-sale unit comprises executing one or more marketing routines using the loyalty promotion table. In an exemplary embodiment, executing one or more marketing routines using the point-of-sale unit comprises at least one of: executing one or more marketing routines to reward the customer with one or more rewards, at least one of the one or more rewards being at least partially dependent upon the at least one characteristic specific to the customer; executing one or more marketing routines to communicate one or more marketing messages to the customer, at least one of the one or more marketing messages being at least partially dependent upon the at least one characteristic specific to the customer; and executing one or more marketing routines to solicit data from the customer, at least a portion of the solicited data being at least partially dependent upon the at least one characteristic specific to the customer. In an exemplary embodiment; executing one or more marketing routines using the point-of-sale unit comprises at least one other of: executing one or more marketing routines to reward the customer with one or more rewards, at least one of the one or more rewards being at least partially dependent upon the at least one characteristic specific to the customer; executing one or more marketing routines to communicate one or more marketing messages to the customer, at least one of the one or more marketing messages being at least partially dependent upon the at least one characteristic specific to the customer; and executing one or more marketing routines to solicit data from the customer, at least a portion of the solicited data being at least partially dependent upon the at least one characteristic specific to the customer.

A method has been described that includes identifying at least one characteristic specific to a customer of a device operably coupled to a point-of-sale unit; and executing one or more marketing routines using the point-of-sale unit; wherein at least one of the one or more marketing routines is at least partially dependent upon the at least one characteristic specific to the customer; wherein the device is selected from the group consisting of a keyboard, a card reader, a pin pad, a computer, a scanner, a fuel dispenser and a kiosk; wherein the at least one characteristic is selected from the group consisting of an area in which the device is located, a payment type used by the customer, a product type desired by the customer, a loyalty identifier used by the customer and data specific to the customer; wherein the point-of-sale unit is in communication with a host computer via a network; wherein a computer readable medium is operably coupled to the host computer, the computer readable medium comprising a loyalty promotion table stored therein; and wherein the method further comprises downloading the loyalty promotion table to the point-of-sale unit via the host computer and the network at one or more predetermined times; wherein executing one or more marketing routines using the point-of-sale unit comprises executing one or more marketing routines using the loyalty promotion table, comprising at least one of: executing one or more marketing routines to reward the customer with one or more rewards, at least one of the one or more rewards being at least partially dependent upon the at least one characteristic specific to the customer; executing one or more marketing routines to communicate one or more marketing messages to the customer, at least one of the one or more marketing messages being at least partially dependent upon the at least one characteristic specific to the customer; and executing one or more marketing routines to solicit data from the customer, at least a portion of the solicited data being at least partially dependent upon the at least one characteristic specific to the customer.

A computer readable medium has been described that includes a plurality of instructions stored therein, the instructions comprising instructions for identifying at least one characteristic specific to a customer of a device operably coupled to a point-of-sale unit; and instructions for executing one or more marketing routines using the point-of-sale unit; wherein at least one of the one or more marketing routines is at least partially dependent upon the at least one characteristic specific to the customer. In an exemplary embodiment, the device comprises a fuel dispenser. In an exemplary embodiment, the device is selected from the group consisting of a keyboard, a card reader, a pin pad, a computer, a scanner, a fuel dispenser and a kiosk. In an exemplary embodiment, the at least one characteristic is selected from the group consisting of an area in which the device is located, a payment type used by the customer, a product type desired by the customer, a loyalty identifier used by the customer and data specific to the customer. In an exemplary embodiment, the point-of-sale unit is in communication with a host computer via a network; wherein the computer readable medium is adapted to be operably coupled to the host computer; and wherein the computer readable medium comprises a loyalty promotion table stored therein. In an exemplary embodiment, the computer readable medium comprises instructions for downloading the loyalty promotion table to the point-of-sale unit via the host computer and the network at one or more predetermined times. In an exemplary embodiment, the instructions for executing one or more marketing routines using the point-of-sale unit comprise instructions for executing one or more marketing routines using the loyalty promotion table. In an exemplary embodiment, the instructions for executing one or more marketing routines using the point-of-sale unit comprise at least one of: instructions for executing one or more marketing routines to reward the customer with one or more rewards, at least one of the one or more rewards being at least partially dependent upon the at least one characteristic specific to the customer; instructions for executing one or more marketing routines to communicate one or more marketing messages to the customer, at least one of the one or more marketing messages being at least partially dependent upon the at least one characteristic specific to the customer; and instructions for executing one or more marketing routines to solicit data from the customer, at least a portion of the solicited data being at least partially dependent upon the at least one characteristic specific to the customer. In an exemplary embodiment, the instructions for executing one or more marketing routines using the point-of-sale unit comprise at least one other of: instructions for executing one or more marketing routines to reward the customer with one or more rewards, at least one of the one or more rewards being at least partially dependent upon the at least one characteristic specific to the customer; instructions for executing one or more marketing routines to communicate one or more marketing messages to the customer, at least one of the one or more marketing messages being at least partially dependent upon the at least one characteristic specific to the customer; and instructions for executing one or more marketing routines to solicit data from the customer, at least a portion of the solicited data being at least partially dependent upon the at least one characteristic specific to the customer.

A computer readable medium has been described that includes a plurality of instructions stored therein, the instructions comprising instructions for identifying at least one characteristic specific to a customer of a device operably coupled to a point-of-sale unit; and instructions for executing one or more marketing routines using the point-of-sale unit; wherein at least one of the one or more marketing routines is at least partially dependent upon the at least one characteristic specific to the customer; wherein the device is selected from the group consisting of a keyboard, a card reader, a pin pad, a computer, a scanner, a fuel dispenser and a kiosk; wherein the at least one characteristic is selected from the group consisting of an area in which the device is located, a payment type used by the customer, a product type desired by the customer, a loyalty identifier used by the customer and data specific to the customer; wherein the point-of-sale unit is in communication with a host computer via a network, the computer readable medium being adapted to be operably coupled to the host computer; wherein the computer readable medium further comprises a loyalty promotion table stored therein and instructions for downloading the loyalty promotion table to the point-of-sale unit via the host computer and the network at one or more predetermined times; and wherein the instructions for executing one or more marketing routines using the point-of-sale unit comprise instructions for executing one or more marketing routines using the loyalty promotion table, comprising at least one of: instructions for executing one or more marketing routines to reward the customer with one or more rewards, at least one of the one or more rewards being at least partially dependent upon the at least one characteristic specific to the customer; instructions for executing one or more marketing routines to communicate one or more marketing messages to the customer, at least one of the one or more marketing messages being at least partially dependent upon the at least one characteristic specific to the customer; and instructions for executing one or more marketing routines to solicit data from the customer, at least a portion of the solicited data being at least partially dependent upon the at least one characteristic specific to the customer.

A system has been described that includes means for identifying at least one characteristic specific to a customer of a device operably coupled to a point-of-sale unit; and means for executing one or more marketing routines using the point-of-sale unit; wherein at least one of the one or more marketing routines is at least partially dependent upon the at least one characteristic specific to the customer. In an exemplary embodiment, the device comprises a fuel dispenser. In an exemplary embodiment, the device is selected from the group consisting of a keyboard, a card reader, a pin pad, a computer, a scanner, a fuel dispenser and a kiosk. In an exemplary embodiment, the at least one characteristic is selected from the group consisting of an area in which the device is located, a payment type used by the customer, a product type desired by the customer, a loyalty identifier used by the customer and data specific to the customer. In an exemplary embodiment, the point-of-sale unit is in communication with a host computer via a network; and wherein a computer readable medium is operably coupled to the host computer, the computer readable medium comprising a loyalty promotion table stored therein. In an exemplary embodiment, the system comprises means for downloading the loyalty promotion table to the point-of-sale unit via the host computer and the network at one or more predetermined times. In an exemplary embodiment, means for executing one or more marketing routines using the point-of-sale unit comprises means for executing one or more marketing routines using the loyalty promotion table. In an exemplary embodiment, means for executing one or more marketing routines using the point-of-sale unit comprises at least one of: means for executing one or more marketing routines to reward the customer with one or more rewards, at least one of the one or more rewards being at least partially dependent upon the at least one characteristic specific to the customer; means for executing one or more marketing routines to communicate one or more marketing messages to the customer, at least one of the one or more marketing messages being at least partially dependent upon the at least one characteristic specific to the customer; and means for executing one or more marketing routines to solicit data from the customer, at least a portion of the solicited data being at least partially dependent upon the at least one characteristic specific to the customer. In an exemplary embodiment, means for executing one or more marketing routines using the point-of-sale unit comprises at least one other of: means for executing one or more marketing routines to reward the customer with one or more rewards, at least one of the one or more rewards being at least partially dependent upon the at least one characteristic specific to the customer; means for executing one or more marketing routines to communicate one or more marketing messages to the customer, at least one of the one or more marketing messages being at least partially dependent upon the at least one characteristic specific to the customer; and means for executing one or more marketing routines to solicit data from the customer, at least a portion of the solicited data being at least partially dependent upon the at least one characteristic specific to the customer.

A system has been described that includes means for identifying at least one characteristic specific to a customer of a device operably coupled to a point-of-sale unit; and means for executing one or more marketing routines using the point-of-sale unit; wherein at least one of the one or more marketing routines is at least partially dependent upon the at least one characteristic specific to the customer; wherein the device is selected from the group consisting of a keyboard, a card reader, a pin pad, a computer, a scanner, a fuel dispenser and a kiosk; wherein the at least one characteristic is selected from the group consisting of an area in which the device is located, a payment type used by the customer, a product type desired by the customer, a loyalty identifier used by the customer and data specific to the customer; wherein the point-of-sale unit is in communication with a host computer via a network; wherein a computer readable medium is operably coupled to the host computer, the computer readable medium comprising a loyalty promotion table stored therein; wherein the system further comprises means for downloading the loyalty promotion table to the point-of-sale unit via the host computer and the network at one or more predetermined times; and wherein means for executing one or more marketing routines using the point-of-sale unit comprises means for executing one or more marketing routines using the loyalty promotion table, comprising at least one of: means for executing one or more marketing routines to reward the customer with one or more rewards, at least one of the one or more rewards being at least partially dependent upon the at least one characteristic specific to the customer; means for executing one or more marketing routines to communicate one or more marketing messages to the customer, at least one of the one or more marketing messages being at least partially dependent upon the at least one characteristic specific to the customer; and means for executing one or more marketing routines to solicit data from the customer, at least a portion of the solicited data being at least partially dependent upon the at least one characteristic specific to the customer.

It is understood that variations may be made in the foregoing without departing from the scope of the invention. For example, in several exemplary embodiments, one or more of the steps of the pre-fueling marketing routine 54, the fueling marketing routine 58 and/or the post-fueling marketing routine 60 may be omitted or combined. Moreover, one or more of the steps and/or routines of the method 50 may be omitted or combined with one or more other steps and/or routines of the method 50. Also, the elements, steps and teachings of the various illustrative embodiments may be combined in whole or in part in some or all of the illustrative embodiments.

Although illustrative embodiments of the invention have been shown and described, a wide range of modification, changes and substitution is contemplated in the foregoing disclosure. In some instances, some features of the present invention may be employed without a corresponding use of the other features, and some steps of the present invention may be executed without a corresponding execution of other steps. Accordingly, all such modifications, changes and substitutions are intended to be included within the scope of this invention as defined in the following claims, and it is appropriate that the claims be construed broadly and in a manner consistent with the scope of the invention. In the claims, means-plus-function clauses are intended to cover the structures described herein as performing the recited function and not only structural equivalents, but also equivalent structures.

What is claimed is:

1. A method of operating a fuel dispenser, the method comprising:
identifying at least one characteristic specific to a customer of the fuel dispenser; and
executing one or more marketing routines;
wherein at least one of the one or more marketing routines is at least partially dependent upon the at least one characteristic specific to the customer of the fuel dispenser.

2. A method of operating a fuel dispenser, the method comprising:
identifying at least one characteristic specific to a customer of the fuel dispenser;
transmitting the at least one characteristic to a remote location;
permitting the customer to dispense fuel from the fuel dispenser; and
executing one or more marketing routines;
wherein at least one of the one or more marketing routines is at least partially dependent upon the at least one characteristic specific to the customer of the fuel dispenser; and
wherein executing one or more marketing routines comprises:
executing a first marketing routine before permitting the customer to dispense fuel from the fuel dispenser, wherein executing the first marketing routine comprises:
determining the availability of a promotion rule;
determining the promotion rule if the promotion rule is available wherein determining the promotion rule comprises looking up a loyalty promotion code in a loyalty promotion table wherein the loyalty promotion table is downloaded from the remote location;
determining the availability of a first reward to the customer in response to determining the availability of a promotion rule and determining the promotion rule;
determining the first reward if the first reward is available; and
providing the first reward to the customer if the first reward is available;
executing a second marketing routine after permitting the customer to dispense fuel from the fuel dispenser, wherein executing the second marketing routine comprises communicating one or more marketing messages to the customer; and
executing a third marketing routine after permitting the customer to dispense fuel from the fuel dispenser, wherein executing the third marketing routine comprises:
communicating at least one message to the customer regarding the providing of the first reward if the first reward is available;
determining the availability of a second reward;
determining the second reward if the second reward is available;
providing the second reward to the customer if the second reward is available; and
soliciting data from the customer.

3. A system comprising:
a host computer;
one or more point-of-sale units in communication with the host computer via a network, each of the one or more point-of-sale units adapted to be operably coupled to one or more fuel dispensers; and
a computer readable medium operably coupled to the host computer, the computer readable medium comprising a database stored therein, the database comprising a loyalty promotion table;
wherein at least a portion of the operation of the one or more fuel dispensers is adapted to be at least partially dependent upon the loyalty promotion table.

4. A system comprising:
a host computer;
one or more point-of-sale units in communication with the host computer via a network, each of the one or more point-of-sale units adapted to be operably coupled to one or more fuel dispensers; and
a computer readable medium operably coupled to the host computer, the computer readable medium comprising a database stored therein, the database comprising a loyalty promotion table adapted to be downloaded to the one or more point-of-sale units via the host computer and the network;
wherein each of the one or more point-of-sale units comprises:
a processor; and
a memory accessible to the processor for storing the loyalty promotion table and for storing instructions executable by the processor, the instructions comprising:
instructions for identifying at least one characteristic specific to a customer of the corresponding fuel dispenser;
instructions for permitting the customer to dispense fuel from the fuel dispenser; and
instructions for executing one or more marketing routines, comprising:
instructions for executing a first marketing routine before executing the permitting instructions, wherein the instructions for executing the first marketing routine comprise instructions for:
determining the availability of a promotion rule;
determining the promotion rule if the promotion rule is available;
determining the availability of a first reward to the customer in response to determining the availability of a promotion rule and determining the promotion rule;
determining the first reward if the first reward is available; and
providing the first reward to the customer if the first reward is available;
instructions for executing a second marketing routine after executing the permitting instructions, wherein the instructions for executing the second marketing routine comprise instructions for communicating one or more marketing messages to the customer; and
instructions for executing a third marketing routine after,executing the permitting instructions, wherein the instructions for executing the third marketing routine comprise instructions for:
determining the availability of a second reward;
determining the second reward if the second reward is available;
providing the second reward to the customer if the second reward is available; and
soliciting data from the customer.

5. A computer readable medium comprising a plurality of instructions stored therein for operating a fuel dispenser, the instructions comprising:
instructions for identifying at least one characteristic specific to a customer of the fuel dispenser; and
instructions for executing one or more marketing routines;
wherein at least one of the one or more marketing routines is at least partially dependent upon the at least one characteristic specific to the customer of the fuel dispenser.

6. A computer readable medium comprising a plurality of instructions stored therein for operating a fuel dispenser, the instructions comprising:
instructions for identifying at least one characteristic specific to a customer of the fuel dispenser;
instructions for permitting the customer to dispense fuel from the fuel dispenser;
instructions for executing one or more marketing routines;
wherein at least one of the one or more marketing routines is at least partially dependent upon the at least one characteristic specific to the customer of the fuel dispenser; and
wherein the instructions for executing one or more marketing routines comprise:
instructions for executing a first marketing routine before executing the permitting instructions, wherein the instructions for executing the first marketing routine comprise:
instructions for determining the availability of a promotion rule;
instructions for determining the promotion rule if the promotion rule is available wherein the instructions for determining the promotion rule comprise:
instructions for looking up a loyalty promotion code in a loyalty promotion table; and
instructions for determining a group discount associated with the loyalty promotion code;
instructions for determining the availability of a first reward to the customer in response to determining the availability of a promotion rule and determining the promotion rule;
instructions for determining the first reward if the first reward is available; and
instructions for providing the first reward to the customer if the first reward is available;
instructions for executing a second marketing routine after executing the permitting instructions, wherein the instructions for executing the second marketing routine comprise instructions for communicating one or more marketing messages to the customer; and
instructions for executing a third marketing routine after executing the permitting instructions, wherein the instructions for executing the third marketing routine comprise:
instructions for determining the availability of a second reward;
instructions for determining the second reward if the second reward is available; and
instructions for providing the second reward to the customer if the second reward is available.

7. A database stored in a computer readable medium and accessible to a device in communication with a fuel dispenser, the database comprising a loyalty promotion table comprising one or more records, each record comprising a discount-type field for identifying a type of reward to apply to a customer of the fuel dispenser; and at least one reward-criteria field for determining whether the reward is available to the customer of the fuel dispenser.

8. A database stored in a computer readable medium and accessible to a processor in communication with a fuel dispenser, the database comprising a loyalty promotion table comprising one or more records, each record comprising a discount-type field for identifying a type of reward to apply to a customer of the fuel dispenser; at least one reward-criteria field for determining whether the reward is available to the customer of the fuel dispenser; at least one message-slot field for indicating a time period during which at least one of the marketing messages are to be communicated; at least one message-slot field for indicating a time period during which at least one of the marketing messages are to be communicated wherein the time period is selected from the group consisting of a time period before the customer is permitted to dispense fuel from the fuel dispenser; and a time period after the customer is permitted to dispense fuel from the fuel dispenser; a solicit-prompt field for prompting the customer to provide one type of data; and a discount-amount field for indicating the value of the reward to apply; wherein the processor and the computer readable medium are components of a point-of-sale unit and the loyalty promotion table is adapted to be downloaded via a network to the computer readable medium for storage therein at one or more predetermined times; wherein, for operating the fuel dispenser, the processor accesses the loyalty promotion table and executes instructions stored in the computer readable medium; and wherein the at least one criteria field is selected from the group consisting of a date/time field for defining the active time period during which the reward is available to the customer of the fuel dispenser; a where-applies field for specifying a location to which the reward applies; a payment-type field for restricting the reward to one or more payment types; a required-purchase-department-code field for indicating a product or service that the customer must purchase; and a required-minimum-purchase-type field for specifying a minimum quantity of a product that the customer must purchase.

9. A system for operating a fuel dispenser, the system comprising:
means for identifying at least one characteristic specific to a customer of the fuel dispenser; and
means for executing one or more marketing routines;
wherein at least one of the one or more marketing routines is at least partially dependent upon the at least one characteristic specific to the customer of the fuel dispenser.

10. A system for operating a fuel dispenser, the system comprising:
means for identifying at least one characteristic specific to a customer of the fuel dispenser;
means for transmitting the at least one characteristic to a remote location;
means for permitting the customer to dispense fuel from the fuel dispenser;
means for executing one or more marketing routines;
wherein at least one of the one or more marketing routines is at least partially dependent upon the at least one characteristic specific to the customer of the fuel dispenser; and
wherein means for executing one or more marketing routines comprises:
means for executing a first marketing routine before permitting the customer to dispense fuel from the fuel dispenser, wherein means for executing the first marketing routine comprises:
means for determining the availability of a promotion rule;
means for determining the promotion rule if the promotion rule is available wherein means for determining the promotion rule comprises means for looking up a loyalty promotion code in a loyalty promotion table wherein the loyalty promotion table is downloaded from the remote location;
means for determining the availability of a first reward to the customer in response to determining the availability of a promotion rule and determining the promotion rule;
means for determining the first reward if the first reward is available; and
means for providing the first reward to the customer if the first reward is available;
means for executing a second marketing routine after permitting the customer to dispense fuel from the fuel dispenser, wherein means for executing the second marketing routine comprises means for communicating one or more marketing messages to the customer; and
means for executing a third marketing routine after permitting the customer to dispense fuel from the fuel dispenser, wherein means for executing the third marketing routine comprises:
means for communicating at least one message to the customer regarding the providing of the first reward if the first reward is available;
means for determining the availability of a second reward;
means for determining the second reward if the second reward is available;
means for providing the second reward to the customer if the second reward is available; and
means for soliciting data from the customer.

11. A method comprising:
identifying at least one characteristic specific to a customer of a device operably coupled to a point-of-sale unit; and
executing one or more marketing routines using the point-of-sale unit;
wherein at least one of the one or more marketing routines is at least partially dependent upon the at least one characteristic specific to the customer.

12. A method comprising:
identifying at least one characteristic specific to a customer of a device operably coupled to a point-of-sale unit; and
executing one or more marketing routines using the point-of-sale unit;
wherein at least one of the one or more marketing routines is at least partially dependent upon the at least one characteristic specific to the customer;
wherein the device is selected from the group consisting of a keyboard, a card reader, a pin pad, a computer, a scanner, a fuel dispenser and a kiosk;
wherein the at least one characteristic is selected from the group consisting of an area in which the device is located, a payment type used by the customer, a product type desired by the customer, a loyalty identifier used by the customer and data specific to the customer;
wherein the point-of-sale unit is in communication with a host computer via a network;
wherein a computer readable medium is operably coupled to the host computer, the computer readable medium comprising a loyalty promotion table stored therein; and
wherein the method further comprises:
downloading the loyalty promotion table to the point-of-sale unit via the host computer and the network at one or more predetermined times;
wherein executing one or more marketing routines using the point-of-sale unit comprises:
executing one or more marketing routines using the loyalty promotion table, comprising at least one of:
executing one or more marketing routines to reward the customer with one or more rewards, at least one of the one or more rewards being at least partially dependent upon the at least one characteristic specific to the customer;
executing one or more marketing routines to communicate one or more marketing messages to the customer, at least one of the one or more marketing messages being at least partially dependent upon the at least one characteristic specific to the customer; and
executing one or more marketing routines to solicit data from the customer, at least a portion of the solicited data being at least partially dependent upon the at least one characteristic specific to the customer.

13. A computer readable medium comprising a plurality of instructions stored therein, the instructions comprising:
instructions for identifying at least one characteristic specific to a customer of a device operably coupled to a point-of-sale unit; and
instructions for executing one or more marketing routines using the point-of-sale unit;
wherein at least one of the one or more marketing routines is at least partially dependent upon the at least one characteristic specific to the customer.

14. A computer readable medium comprising a plurality of instructions stored therein, the instructions comprising:
instructions for identifying at least one characteristic specific to a customer of a device operably coupled to a point-of-sale unit; and
instructions for executing one or more marketing routines using the point-of-sale unit;
wherein at least one of the one or more marketing routines is at least partially dependent upon the at least one characteristic specific to the customer;
wherein the device is selected from the group consisting of a keyboard, a card reader, a pin pad, a computer, a scanner, a fuel dispenser and a kiosk;
wherein the at least one characteristic is selected from the group consisting of an area in which the device is located, a payment type used by the customer, a product type desired by the customer, a loyalty identifier used by the customer and data specific to the customer;
wherein the point-of-sale unit is in communication with a host computer via a network, the computer readable medium being adapted to be operably coupled to the host computer;
wherein the computer readable medium further comprises a loyalty promotion table stored therein and instructions for downloading the loyalty promotion table to the point-of-sale unit via the host computer and the network at one or more predetermined times; and
wherein the instructions for executing one or more marketing routines using the point-of-sale unit comprise:
instructions for executing one or more marketing routines using the loyalty promotion table, comprising at least one of:
instructions for executing one or more marketing routines to reward the customer with one or more rewards, at least one of the one or more rewards being at least partially dependent upon the at least one characteristic specific to the customer;
instructions for executing one or more marketing routines to communicate one or more marketing messages to the customer, at least one of the one or more marketing messages being at least partially dependent upon the at least one characteristic specific to the customer; and
instructions for executing one or more marketing routines to solicit data from the customer, at least a portion of the solicited data being at least partially dependent upon the at least one characteristic specific to the customer.

15. A system comprising:
means for identifying at least one characteristic specific to a customer of a device operably coupled to a point-of-sale unit; and
means for executing one or more marketing routines using the point-of-sale unit;
wherein at least one of the one or more marketing routines is at least partially dependent upon the at least one characteristic specific to the customer.

16. A system comprising:
means for identifying at least one characteristic specific to a customer of a device operably coupled to a point-of-sale unit; and
means for executing one or more marketing routines using the point-of-sale unit;
wherein at least one of the one or more marketing routines is at least partially dependent upon the at least one characteristic specific to the customer;
wherein the device is selected from the group consisting of a keyboard, a card reader, a pin pad, a computer, a scanner, a fuel dispenser and a kiosk;
wherein the at least one characteristic is selected from the group consisting of an area in which the device is located, a payment type used by the customer, a product type desired by the customer, a loyalty identifier used by the customer and data specific to the customer;
wherein the point-of-sale unit is in communication with a host computer via a network;
wherein a computer readable medium is operably coupled to the host computer, the computer readable medium comprising a loyalty promotion table stored therein;
wherein the system further comprises:
means for downloading the loyalty promotion table to the point-of-sale unit via the host computer and the network at one or more predetermined times; and
wherein means for executing one or more marketing routines using the point-of-sale unit comprises:
means for executing one or more marketing routines using the loyalty promotion table, comprising at least one of:
means for executing one or more marketing routines to reward the customer with one or more rewards, at least one of the one or more rewards being at least partially dependent upon the at least one characteristic specific to the customer;
means for executing one or more marketing routines to communicate one or more marketing messages to the customer, at least one of the one or more marketing messages being at least partially dependent upon the at least one characteristic specific to the customer; and
means for executing one or more marketing routines to solicit data from the customer, at least a portion of the solicited data being at least partially dependent upon the at least one characteristic specific to the customer.
